(19) United States
(12) Patent Application Publication
(10) Pub. No.: US 2016/0024327 A1
(43) Pub. Date: Jan. 28, 2016

(54) DISPERSED COMPOSITION, COATING COMPOSITION, COATING FILM, AND COLORED ITEM

(71) Applicants: TOYO INK SC HOLDINGS CO., LTD., Chuo-ku, Tokyo (JP); TOYOCOLOR CO. , LTD., Chuo-ku, Tokyo (JP)

(72) Inventors: Masahiro OOKAWA, Tokyo (JP); Takeshi NISHINAKA, Tokyo (JP); Tetsuro OIZUMI, Tokyo (JP); Tsutomu HAYASAKA, Tokyo (JP)

(73) Assignees: TOYO INK HOLDINGS CO., LTD., Chuo-ku, Tokyo (JP); TOYOCOLOR CO., LTD, Chuo-ku, Tokyo (JP)

(21) Appl. No.: 14/760,926

(22) PCT Filed: May 20, 2013
(86) PCT No.: PCT/JP2013/063926

§ 371 Date: Jul. 14, 2015

(30) Foreign Application Priority Data
Jan. 17, 2013 (JP) 2013-006492

(51) Int. Cl. C09D 133/00; C09D 163/00; C08K 5/13; C08K 3/22

(52) U.S. Cl. CPC C09D 133/00; C08K 3/22; C09D 163/00; C08K 5/13; C08K 2003/2265; C08K 2003/2262

(57) ABSTRACT

The present invention provides a dispersed composition containing an ultramarine (A), a black inorganic pigment (B) (excluding carbon black), and a dispersion medium (C), wherein the weight ratio of ultramarine (A)/black inorganic pigment (B) is from 80/20 to 4.3/95.7. As a result, the invention provides a coating film and a colored item having a high surface resistivity (an antistatic effect) and resistance to overheating by sunlight, as well as a coating composition for forming this coating film and colored item, for use in fields such as black matrices for color filters and automotive coating materials.

### TECHNICAL FIELD

The present invention relates to a dispersed composition having a high surface resistivity, a high degree of blackness and favorable storage stability, as well as a coating film and a colored item which use the composition.

### BACKGROUND ART

Conventionally, carbon blacks have mainly been used for black pigments having an excellent light-blocking effect and superior weather resistance. However, carbon blacks have problems in that the degree of blackness is inadequate and the surface resistivity of the formed coating film is low.

In terms of the blackness, because carbon blacks generally tend to be a reddish black, methods of enhancing the blackness by adding a blue pigment (a blue ink) such as a phthalocyanine pigment have been proposed (Patent Documents 1 and 2). However, when a phthalocyanine pigment is used, the storage stability is poor, and the resulting product is unsatisfactory as a dispersed composition.

On the other hand, examples of light-blocking agents having a high surface resistivity which have been proposed include an example in which a high surface resistivity black matrix is formed using two or more metal oxides (Patent Document 3), and an example in which a carbon black is dispersed using a specific dispersant (Patent Document 4). However, the surface resistivity of a coating film using a carbon black is typically a low value of about 10⁵ to 10⁸ Ω/square, which is inadequate for practical application in fields that require low conductivity (superior insulation properties, high surface resistivity) such as black matrix coating materials and electrodeposition coating materials used in automotive applications. Moreover, black coating films containing dispersed iron black in accordance with these prior art documents have inferior blackness, with a lightness (L value) of 27.0 or greater, and are therefore limited in terms of their use in coating material applications.

Further, in recent years, outdoor temperatures in urban areas have increased dramatically, particularly in the summer, due to the radiated heat from man-made structures of concrete and the like, and the hot air discharged from the outside units of air conditioners. This problem, known as the heat island phenomenon, is becoming a significant social problem. In response to this problem, the increased use of cooling necessary to maintain the desired internal temperature inside buildings has not only lead to an increase in power consumption, but has also resulted in an acceleration in the outdoor temperature increases due to the exhaust gases from the outside units of air conditioners.

One known method of suppressing temperature increases inside a building is a method that uses a shielding coating composition on the exterior facing materials used for the roof and the exterior walls and the like. On the other hand, a known method of suppressing temperature increases inside automobiles is a method that uses shielding coating compositions on members inside the vehicle.

Examples of heat-shielding coating materials that have been proposed include the following.

A coating composition has been proposed which has superior solar radiation reflectance in the near infrared region and is an achromatic black due to additive color mixing of two or more organic pigments containing no heavy metals, wherein a coating composition composed of carbon or titanium oxide is added to improve the reflectance (see Patent Document 5).

Further, a shielding coating material has been proposed in which, by combining a top coat material composed of an organic pigment having a solar heat reflectance greater than a specified value with an undercoat material containing an inorganic pigment and titanium oxide, a low lightness value similar to that of carbon can be obtained by additive color mixing (see Patent Document 6). Furthermore, a shielding coating material has also been proposed in which, by combining iron oxide red with an organic pigment, a low lightness value similar to that of carbon is obtained by additive color mixing (Patent Document 7).

Moreover, a shielding coating material has been proposed in which an azo-methine azo-based black pigment which exhibits reflectance in the near infrared region is used instead of carbon, and is mixed with a white pigment such as titanium oxide (see Patent Document 8).

Further, an electrodeposition shielding coating material has been proposed in which, by combining an organic pigment having a shielding effect and an inorganic pigment, a coating material containing an epoxy emulsion capable of generating a blackness similar to carbon black is obtained (see Patent Document 9).

A shielding coating material has also been proposed in which, by combining two or more organic pigments which exhibit absorption in the visible light region and have a reflectance of at least 35% in the near infrared region, a black color having a favorable Munsell code of N−1 is generated (see Patent Document 10).

A heat-shielding coating material has been proposed which uses a bismuth composite oxide having a high light reflectance in the near infrared region and excellent blackness as a black pigment (see Patent Document 11).

Furthermore, a heat-shielding coating material containing a perylene pigment and an organic pigment has also been proposed (see Patent Document 12).

However, the heat-shielding coating materials of Patent Documents 5, 6, 8 and 9 use pigments having inferior weather resistance to carbon black, and therefore suffer from problems such as a deterioration in the gloss and changes in the hue.

Further, the heat-shielding coating materials of Patent Documents 6 and 7 use organic pigments having inferior weather resistance, and therefore degradation over time tends to cause problems such as a deterioration in the gloss and changes in the hue.

Furthermore, in the heat-shielding coating material of Patent Document 10, the blackness is inferior to that of carbon black, and because the weather resistance of the organic pigment that is used is also poor, fading is a problem.

Moreover, in the heat-shielding coating material of Patent Document 11, a step of adhering the bismuth composite oxide to the surface of a white pigment is required when producing the pigment, and therefore the production process required to achieve favorable blackness becomes more complex.

In the heat-shielding coating material of Patent Document 12, the weather resistance is poor, and the blackness is also inferior to that of carbon black.

### PRIOR ART DOCUMENTS

### Patent Documents

Patent Document 1: JP 58-167654 A

Patent Document 2: JP 01-038453 A

Patent Document 3: JP 10-204321 A

Patent Document 4: JP 2003-344996 A

Patent Document 5: JP 04-255769 A

Patent Document 6: JP 05-293434 A

Patent Document 7: JP 2009-286862 A

Patent Document 8: JP 2000-129172 A

Patent Document 9: JP 2000-212475 A

Patent Document 10: JP 2002-20647 A

Patent Document 11: JP 2007-145989 A

Patent Document 12: JP 2009-76693 A

### SUMMARY OF THE INVENTION

The present invention has an object of providing: (1) a dispersed composition having excellent weather resistance, a high degree of blackness and excellent storage stability, (2) a coating film or colored item which, when used in a field such as a black matrix for a color filter used in any of various displays, or an automotive coating material, can provide a high surface resistivity (an antistatic effect) at the same time as the above-mentioned weather resistance, blackness and storage stability, and (3) a coating composition which, in the field of heat-shielding coating materials, can be produced using a simple method, and is capable of forming a coating film or a colored item that readily transmits infrared radiation and is therefore resistant to overheating by sunlight.

The inventors of the present invention discovered that a dispersed composition of excellent storage stability obtained by combining an ultramarine (A) and a black inorganic pigment (B), and a coating film or a colored item obtained using this dispersed composition, had excellent weather resistance and a high degree of blackness, and also exhibited a high surface resistivity (an antistatic effect) and excellent infrared permeability (sunlight reflectivity), and they were therefore able to complete the present invention.

In other words, the present invention relates to: (1) a dispersed composition comprising an ultramarine (A), a black inorganic pigment (B) (excluding carbon black), and a dispersion medium (C), wherein the weight ratio of ultramarine (A)/black inorganic pigment (B) is from 80/20 to 4.3/95.7.

The present invention also relates to: (2) the dispersed composition according to (1) above, wherein the black inorganic pigment (B) is a black inorganic pigment composed of a metal oxide.

Moreover, the present invention also relates to: (3) the dispersed composition according to (1) or (2) above, wherein the black inorganic pigment (B) is C.I. Pigment Black 11 or C.I. Pigment Black 33.

The present invention also relates to: (4) the coating composition according to any one of (1) to (3) above, wherein the D50 average particle size of the ultramarine (A) is from 0.1 to 1 μm, and the D50 average particle size of the black inorganic pigment (B) is from 0.1 to 1 μm.

Moreover, the present invention also relates to: (5) the coating composition according to any one of (1) to (4) above, wherein the D99 average particle size of the ultramarine (A) is from 1 to 10 μm.

The present invention also relates to: (6) the coating composition according to any one of (1) to (5) above, wherein the D99 average particle size of the black inorganic pigment (B) is from 1 to 10

The present invention also relates to: (7) the coating composition according to any one of (1) to (6) above, further comprising a dispersant (D).

Moreover, the present invention also relates to: (8) the coating composition according to any one of (1) to (7) above, wherein the dispersion medium (C) comprises an organic solvent.

The present invention also relates to: (9) the coating composition according to any one of (1) to (8) above, wherein the dispersion medium (C) comprises one or more organic solvents selected from the group consisting of ketones, esters, alcohols, ethers, and aromatic hydrocarbons.

Moreover, the present invention also relates to: (10) the coating composition according to any one of (1) to (7) above, wherein the dispersion medium (C) comprises water, and at least one solvent selected from the group consisting of water-soluble organic solvents.

The present invention also relates to: (11) the coating composition according to any one of (1) to (10) above, wherein the dispersant (D) is at least one of a nonionic surfactant and an anionic surfactant. Moreover, the present invention also relates to: (12) the coating composition according to any one of (1) to (10) above, wherein the dispersant (D) is a resin-type dispersant.

In addition, the present invention relates to: (13) a coating composition comprising the dispersed composition according to any one of (1) to (12) above, and at least one of a binder resin (E) and a curing agent (F).

The present invention also relates to: (14) a coating film formed from the coating composition according to (13) above.

Moreover, the present invention also relates to: (15) the coating film according to (14) above, wherein the surface resistivity of the coating film is 10¹⁰ Ω/square or greater.

The present invention also relates to: (16) the coating film according to (14) or (15) above, wherein the lightness (L value) of the coating film is 22.0 or less.

In addition, the present invention relates to: (17) a colored item comprising a substrate and the coating film according to any one of (14) to (16) above.

The disclosure of the present invention is related to the subject matter disclosed in prior Japanese Application 2013-006492 filed on Jan. 17, 2013, the entire contents of which are incorporated herein by reference.

The present invention is able to provide a dispersed composition and a black coating composition having excellent storage stability, blackness and weather resistance. Further, the invention can also provide a black dispersed composition, a black coating composition and a coating film which have high surface resistivity (an antistatic effect). These compositions and coating films are useful in fields such as black matrices for color filters used in any of various displays, and interior and exterior automotive coating materials, which require a high degree of blackness and a high surface resistivity. Further, the present invention can also provide a black dispersed composition and a heat-shielding coating film that exhibit excellent infrared permeability, and are therefore useful in fields such as shielding coating materials which require a high degree of blackness and superior infrared permeability.

### EMBODIMENTS

The present invention is described below in further detail based on a series of embodiments. Unless specifically stated otherwise, the abbreviation “C.I.” used in the present description means “Color Index Generic Name”.

### <Ultramarine (A)>

The ultramarine (A) used in the present invention is the pigment represented by C.I. Pigment Blue 29, and there are no particular limitations within the range specified by this pigment. Ultramarine is a sodium silicate complex which contains sulfur, and has a chemical composition represented by Na₈₋₁₀Al₆Si₆O₂₄S₂₋₄. One well known representative composition is Na₆(Al₆Si₆O₂₄).2NaS₃. Specific examples of ultramarine include Gunjo 8600P, ED-05S and ED-10S (all manufactured by Daiichi Kasei Kogyo Co, Ltd.), Nubix G58, Nubix EP62 and Nubcoat HWR (all manufactured by Nubiola), Ultramarine Blue 07T, Ultramarine 17, Ultramarine 32T, Ultramarine 51T, Ultramarine 56, Ultramarine 57, Ultramarine 62, Ultramarine 63/05, Ultramarine 74, Ultramarine 75 and Ultramarine 91 (all manufactured by Holliday Pigments SA).

From the viewpoint of the infrared permeability, the ultramarine (A) preferably has a D50 average particle size of 0.1 to 1 μm. By ensuring this range is satisfied, the combination with the black inorganic pigment (B) described below allows more ready transmission of infrared radiation, enabling the formation of a coating film that is resistant to overheating by sunlight. The D50 average particle size describes the average diameter of the particle at a value of 50% in the cumulative distribution measured by the light scattering method.

Furthermore, the D99 average particle size for the ultramarine (A) is preferably from 1 to 10 μm, and more preferably from 1 to 4 μm. By ensuring this range is satisfied, the effect of the combination with the black inorganic pigment (B) can be enhanced. The D99 average particle size describes the average diameter of the particle at a value of 99% in the cumulative distribution measured by the light scattering method.

### <Black Inorganic Pigment (B)>

The black inorganic pigment (B) used in the present invention is required to absorb light in the visible light region (wavelength: 400 to 800 nm), while being resistant to temperature increases caused by infrared light absorption, and examples of such pigments include black inorganic pigments other than carbon black. Specific examples include black inorganic pigments such as metal oxides, metal sulfides and metal silicates, and a black inorganic pigment composed of a metal oxide is preferable.

Specific examples of black inorganic pigments composed of a metal oxide include black inorganic pigments containing, as the main component, an oxide of a metal selected from the metals group composed of metals of groups 4 to 11 and period 4 (namely, Ti, V, Cr, Mn, Fe, Co, Ni and Cu), or an oxide containing two or more metals selected from the above metals group. Examples of composite metal oxides containing two or more metals selected from the above metals group include oxides containing Mn—Cu, Cr—Mn, Cu—Cr, Ni—Cu, Cr—Fe, Fe—Co, Fe—Cu, Fe—Mn, Ti—Mn—Cu, Mn—Fe—Cu, Co—Fe—Cr, Cr—Mn—Cu, or Cr—Cu—Fe.

Accordingly, specific examples include inorganic black pigments composed of one or more metal oxides selected from the group consisting of iron oxide (Fe₂O₃), triiron tetroxide (Fe₃O₄), cobalt oxide (CoO), cobalt(II) oxide, Co₂O₃(H₂O), cobalt(III) oxide, Co₃O₄, cobalt(II,III) oxide, chromium oxide (Cr₂O₃), manganese oxide (MnO₂), copper oxide (CuO), aluminum oxide and nickel oxide. Additional examples include mixtures of iron oxide, chromium oxide and aluminum oxide, mixtures of iron oxide, chromium oxide, nickel oxide and cobalt oxide, mixtures of iron oxide, chromium oxide, cobalt oxide and aluminum oxide, mixtures of iron oxide and manganese oxide, and black inorganic pigments containing any of the above mixtures as the main component. Any of the above black inorganic pigments may be used individually, or combinations of two or more black inorganic pigments may be used. Of the above, black inorganic pigments containing iron oxide, manganese oxide, or a mixture thereof as the main component can be used particularly favorably.

In terms of Color Index Generic Names, examples of the black inorganic pigment used in the present invention include C.I. Pigment Black 11, 12, 13, 14, 15, 17, 18, 23, 24, 25, 26, 27, 28, 29, 30, 33, 34 and 35, and of these, C.I. Pigment Black 11, 12, 13, 14, 15, 26, 29, 30, 33 and 35 are preferable, C.I. Pigment Black 11, 14, 15, 29, 33 and 35 are more preferable, and C.I. Pigment Black 11 and 33 are particularly desirable.

The C.I. Pigment Black 11 is not particularly limited within the range specified by the pigment. This pigment is generally a black inorganic pigment containing triiron tetroxide (Fe₃O₄), also known as “iron black”, as the main component. Specific examples include BAYFERROX (a registered trademark) 306, 318, 318G, 318M, 318 MB, 320, 330, 330C, 340, 360, 360Z and 365GP (all manufactured by LANXESS AG), and TAROX BL-100, BL-50, ABL-205, BL-10 and BL-SP (all manufactured by Titan Kogyo, Ltd.) From the viewpoints of the degree of blackness and the weather resistance, BAYFERROX 303T (manufactured by LANXESS AG) is preferable.

The C.I. Pigment Black 33 is not particularly limited within the range specified by the pigment. This pigment is generally a black inorganic pigment containing iron oxide (Fe₂O₃) as the main component, and also containing manganese oxide (MnO). For production reasons, the pigment may sometimes also contain small amounts of aluminum oxide and silicon oxide. Specific examples include BAYFERROX (a registered trademark) 306 (manufactured by LANXESS AG), and Plirox (a registered trademark) B5T (manufactured by Pigment International GmbH).

The black inorganic pigment (B) preferably has a D50 average particle size of 0.1 to 1 μm. Ensuring this range is satisfied facilitates more uniform dispersion of the ultramarine (A) and the black inorganic pigment (B) within the coating film.

Further, the D99 average particle size for the black inorganic pigment (B) is preferably from 1 to 10 μm, and more preferably from 1 to 4 μm. By ensuring this range is satisfied, the effect of the combination with the black inorganic pigment (B) can be enhanced.

In terms of achieving a favorable combination of blackness, weather resistance and infrared permeability, the weight ratio of ultramarine (A)/black inorganic pigment (B) in those cases when the dispersion medium is water is preferably from 80/20 to 4.3/95.7, more preferably from 70/30 to 4.5/95.5, and still more preferably from 60/40 to 30/70. A weight ratio from 52/48 to 40/60 is particularly desirable.

In those cases when the dispersion medium is a water-soluble or water-insoluble organic solvent, the weight ratio of ultramarine (A)/black inorganic pigment (B) is preferably from 80/20 to 4.3/95.7, more preferably from 70/30 to 25/75, still more preferably from 55/45 to 35/65, and particularly preferably from 45/55 to 35/65.

In those cases when the dispersion medium is a mixture of water and an organic solvent, the preferred weight ratio can be determined in accordance with the mixing ratio by appropriate apportionment of the two sets of preferred ranges described above.

If the amount of the black inorganic pigment (B) exceeds the above range and the amount of the ultramarine (A) is less than the above range, then the reddish black that represents the color of the black inorganic pigment (B) itself strengthens, meaning the degree of blackness may deteriorate undesirably. In contrast, if the amount of the ultramarine (A) exceeds the above range, then the color shifts from reddish black to bluish black, and the lightness and degree of blackness may deteriorate undesirably.

In the present invention, other pigments may also be used in combination in order to adjust the color tone.

Examples of red pigments which may be used include C.I. Pigment Red 7, 14, 41, 48:1, 48:2, 48:3, 48:4, 57:1, 81, 81:1, 81:2, 81:3, 81:4, 122, 146, 168, 176, 177, 178, 184, 185, 187, 200, 202, 208, 210, 242, 246, 254, 255, 264, 270, 272 and 279.

Examples of green pigments include C.I. Pigment Green 1, 2, 4, 7, 8, 10, 13, 14, 15, 17, 18, 19, 26, 36, 45, 48, 50, 51, 54, 55 and 58.

Examples of blue pigments include C.I. Pigment Blue 1, 1:2, 9, 14, 15, 15:1, 15:2, 15:3, 15:4, 15:6, 16, 17, 19, 25, 27, 28, 33, 35, 36, 56, 56:1, 60, 61, 61:1, 62, 63, 66, 67, 68, 71, 72, 73, 74, 75, 76, 78 and 79.

Examples of yellow pigments include C.I. Pigment Yellow 1, 2, 3, 4, 5, 6, 10, 12, 13, 14, 15, 16, 17, 18, 24, 31, 32, 34, 35, 35:1, 36, 36:1, 37, 37:1, 40, 42, 43, 53, 55, 60, 61, 62, 63, 65, 73, 74, 77, 81, 83, 93, 94, 95, 97, 98, 100, 101, 104, 106, 108, 109, 110, 113, 114, 115, 116, 117, 118, 119, 120, 123, 126, 127, 128, 129, 138, 139, 147, 150, 151, 152, 153, 154, 155, 156, 161, 162, 164, 166, 167, 168, 169, 170, 171, 172, 173, 174, 175, 176, 177, 179, 180, 181, 182, 184, 185, 187, 188, 193, 194, 198, 199, 213 and 214.

Examples of violet pigments include C.I. Pigment Violet 1, 1:1, 2, 2:2, 3, 3:1, 3:3, 5, 5:1, 14, 15, 16, 19, 23, 25, 27, 29, 31, 32, 37, 39, 42, 44, 47, 49 and 50.

### <Dispersion Medium (C)>

The dispersion medium (C) used in the present invention may be water, a water-soluble organic solvent, or a mixture thereof. Further, one or more water-insoluble organic solvents may also be used as the dispersion medium (C).

The dispersion medium is used for the purpose of obtaining the desired dispersed composition or coating composition, and a single dispersion medium may be used alone, or a mixture of two or more dispersion media may be used, provided they do not undergo phase separation.

The dispersion medium (C) in the present invention may contain an organic solvent, and can use one or more organic solvents selected from the group consisting of ketones, esters, alcohols, ethers, and aromatic hydrocarbons.

Specific examples of the ketones include acetone, methyl ethyl ketone, methyl isobutyl ketone, diethyl ketone, methyl propyl ketone, methyl amyl ketone, methyl isoamyl ketone, diisobutyl ketone, cyclohexanone and isophorone. Examples of the esters include methyl acetate, ethyl acetate, propyl acetate, isopropyl acetate, butyl acetate, isobutyl acetate, methoxypropyl acetate, methoxybutyl acetate, cellosolve acetate, amyl acetate, 3-ethoxyethanol acetate, methyl propionate, ethyl propionate, propyl propionate, isopropyl propionate, butyl propionate, isobutyl propionate, methoxypropyl propionate, methoxybutyl propionate, cellosolve propionate, amyl propionate, 3-ethoxyethanol propionate, methyl butyrate, ethyl butyrate, propyl butyrate, isopropyl butyrate, butyl butyrate, isobutyl butyrate, methoxypropyl butyrate, methoxybutyl butyrate, cellosolve butyrate, amyl butyrate, 3-ethoxyethanol butyrate, methyl isobutyrate, ethyl isobutyrate, propyl isobutyrate, isopropyl isobutyrate, butyl isobutyrate, isobutyl isobutyrate, methoxypropyl isobutyrate, methoxybutyl isobutyrate, cellosolve isobutyrate, amyl isobutyrate, 3-ethoxyethanol isobutyrate, methyl lactate, ethyl lactate, butyl lactate and 1-methoxypropyl-2-acetate.

Examples of the alcohols include methyl alcohol, ethyl alcohol, n-propyl alcohol, n-butyl alcohol, sec-butyl alcohol, tert-butyl alcohol, n-amyl alcohol, amyl alcohol, isoamyl alcohol, tert-amyl alcohol, ethylene glycol, propylene glycol, diethylene glycol and dipropylene glycol. Examples of the ethers include isopropyl ether, methyl cellosolve, ethyl cellosolve, propyl cellosolve, butyl cellosolve, phenyl cellosolve, diethylene glycol monomethyl ether, diethylene glycol monoethyl ether, diethylene glycol monopropyl ether, diethylene glycol monobutyl ether, diethylene glycol monophenyl ether, propylene glycol monomethyl ether, propylene glycol monoethyl ether, propylene glycol monopropyl ether, propylene glycol monobutyl ether, propylene glycol monophenyl ether, dipropylene glycol monomethyl ether, dipropylene glycol monoethyl ether, dipropylene glycol monopropyl ether, dipropylene glycol monobutyl ether, dipropylene glycol monophenyl ether, and dioxane.

Examples of the aromatic hydrocarbons include benzene, toluene, o-xylene, m-xylene, p-xylene, ethylbenzene and styrene.

Moreover, if required, other organic solvents besides those listed above may also be used in combination with the above solvent. Examples of these other organic solvents include petroleum benzine, mineral spirit and solvent naphtha.

Examples of the water-soluble organic solvent include alkyl alcohols having a carbon number of 1 to 4, such as methyl alcohol, ethyl alcohol, n-propyl alcohol, n-butyl alcohol, sec-butyl alcohol and tert-butyl alcohol; amides such as dimethylformamide and dimethylacetamide; ketones and keto alcohols such as acetone and diacetone alcohol; ethers such as tetrahydrofuran and dioxane; nitrogen-containing heterocyclic ketones such as N-methyl-2-pyrrolidone and 1,3-dimethyl-2-imidazolidinone; polyalkylene glycols such as polyethylene glycol and polypropylene glycol; alkylene glycols in which the alkylene group contains 2 to 6 carbon atoms, such as ethylene glycol, propylene glycol, butylene glycol, triethylene glycol, 1,2,6-hexanetriol, thiodiglycol, hexylene glycol and diethylene glycol; glycerol; and lower alcohol ethers of polyhydric alcohols, such as ethylene glycol methyl ether, diethylene glycol (ethyl) methyl ether, and triethylene glycol (ethyl) methyl ether.

The blend amount of the water-soluble organic solvent, regardless of whether a single organic solvent or a plurality of organic solvents are used, preferably totals 1 to 20% by weight, and more preferably 3 to 10% by weight, relative to the amount of water. Provided the blend amount of the water-soluble organic solvent is not too large, the wetting effect on the pigment does not become excessive, and the compatibility with the surfactant remains favorable. On the other hand, provided the blend amount of the water-soluble organic solvent is not too small, the wetting action on the pigment is adequate, and the compatibility with the surfactant remains favorable.

### <Dispersant (D)>

The pigments such as the ultramarine (A) and the black inorganic pigment (B) are preferably converted to a dispersed composition using a dispersant prior to use.

Surfactants and resin-type dispersants can be used as the dispersant (D) used in the present invention. Surfactants are mainly classified as anionic, cationic, nonionic or amphoteric, and an appropriate blend amount of an appropriate type of surfactant may be used in accordance with the properties required. A nonionic surfactant or anionic surfactant is preferred.

In those cases when the dispersion medium is either water or a mixture containing water as the main component, the dispersant (D) is preferably a surfactant, and most preferably a nonionic or anionic surfactant. When the dispersion medium is either an organic solvent or a mixture containing an organic solvent as the main component, the dispersant (D) is preferably a resin-type dispersant.

There are no particular limitations on the anionic surfactant, and examples include salts of fatty acids, polysulfonates, polycarboxylates, alkyl sulfate ester salts, alkyl aryl sulfonates, alkyl naphthalene sulfonates, dialkyl sulfonates, dialkyl sulfosuccinates, alkyl phosphates, polyoxyethylene alkyl ether sulfates, polyoxyethylene alkyl aryl ether sulfates, naphthalene sulfonic acid-formalin condensates, polyoxyethylene alkyl phosphate sulfonates, glycerol borate fatty acid esters, and polyoxyethylene glycerol fatty acid esters. Specific examples include sodium dodecylbenzene sulfonate, sodium laurate sulfate, sodium polyoxyethylene lauryl ether sulfate, polyoxyethylene nonylphenyl ether sulfate ester salts, and the sodium salt of β-naphthalenesulfonic acid-formalin condensate. Among these anionic surfactants, polycarboxylates are preferred.

Examples of the cationic surfactant include alkyl amine salts and quaternary ammonium salts. Specific examples include stearyl amine acetate, coco alkyl trimethyl ammonium chloride, trimethyl(tallow alkyl)ammonium chloride, dimethyldioleylammonium chloride, methyl oleyl diethanol chloride, tetramethylammonium chloride, laurylpyridinium chloride, laurylpyridinium bromide, laurylpyridinium disulfate, cetylpyridinium bromide, 4-alkylmercaptopyridine, poly(vinylpyridine)-dodecyl bromide, and dodecylbenzyl triethyl ammonium chloride. Examples of the amphoteric surfactant include aminocarboxylates.

Examples of the nonionic surfactant include polyoxyethylene alkyl ethers, polyoxyalkylene derivatives, polyoxyethylene phenyl ethers, sorbitan fatty acid esters, polyoxyethylene sorbitan fatty acid esters, and alkyl allyl ethers. Specific examples include polyoxyethylene lauryl ether, sorbitan fatty acid esters, and polyoxyethylene octyl phenyl ether. Among these nonionic surfactants, polyoxyethylene phenyl ethers are preferable.

When selecting the surfactant, the surfactant need not be limited to a single surfactant, and combinations of two or more surfactants may also be used, including a combination of an anionic surfactant and a nonionic surfactant, or a combination of a cationic surfactant and a nonionic surfactant. In the case of such combinations, the blend amounts described above are preferably applied to each of the surfactant components. A combination of an anionic surfactant and a nonionic surfactant is preferable.

The resin-type dispersant has an affinity site which has the property of adsorbing to the ultramarine and the black inorganic pigment, and a compatibility site which exhibits compatibility with the dispersion medium, and has the functions of adsorbing to the ultramarine and the black inorganic pigment and stabilizing the dispersion of the pigments within the dispersion medium. Specific examples of resin-type dispersants that can be used include polyurethanes; polycarboxylates such as polyacrylates; unsaturated polyamides, polycarboxylic acids, (partial) amine salts of polycarboxylic acids, ammonium salts of polycarboxylic acids, alkyl amine salts of polycarboxylic acids, polysiloxanes, long-chain polyaminoamide phosphates, hydroxyl group-containing polycarboxylates, and modified products of these compounds; oil-based dispersants such as amides formed by a reaction between a poly(lower alkyleneimine) and a polyester having free carboxyl groups, and salts thereof; water-soluble resins and water-soluble polymer compounds such as (meth)acrylic acid-styrene copolymers, (meth)acrylic acid-(meth)acrylate ester copolymers, styrene-maleic acid copolymers, polyvinyl alcohol and polyvinylpyrrolidone; as well as polyester-based resins, modified polyacrylate-based resins, ethylene oxide/propylene oxide adducts and phosphate ester-based resins. These resin-type dispersants may be used individually, or in mixtures containing two or more dispersants, but the resin-type dispersant is not necessarily limited to those listed above.

Among the above resin-type dispersants, a polymer dispersant having acidic functional groups such as a polycarboxylic acid is preferable, because it enables the viscosity of the dispersed composition to be lowered by adding only a small amount of the dispersant, and also exhibits a high level of spectral transmittance.

A large variety of resin-type dispersants are available commercially, and there are no particular limitations on the variety of the dispersant. Examples include the BYK (a registered trademark) and DISPERBYK (a registered trademark) series manufactured by BYK Chemie GmbH, the SOLSPERSE (a registered trademark) series manufactured by Lubrizol Japan Ltd., and the EFKA (a registered trademark) manufactured by BASF Corporation.

Specific examples of commercially available resin-type dispersants include:

the aforementioned DISPERBYK products manufactured by BYK Chemie GmbH, including DISPERBYK-101 (a salt of a long-chain polyaminoamide and an acidic polyester), 103, 107 and 108 (hydroxyl group-containing carboxylate esters), 110 and 111 (copolymers having acidic groups), 116 (an acrylate copolymer), 130 (a polyamine amide of an unsaturated polycarboxylic acid), 140 (an alkylammonium salt of an acidic polymer), 154 (an ammonium salt of an acrylic copolymer), 161, 162, 163, 164, 165, 166, 170, 171 and 174 (high-molecular weight block copolymers having pigment affinity groups), 180 (an alkylolammonium salt of a copolymer having acidic groups), 181 (an alkylolammonium salt of a polyfunctional polymer), 182, 183, 184, 185 and 190 (high-molecular weight block copolymers having pigment affinity groups), 2000 and 2001 (modified acrylate block copolymers), 2020 (a saturated acrylate copolymer), 2025 (an acrylate copolymer having pigment affinity groups), 2050 (an acrylate copolymer having basic pigment affinity groups), 2070 (an acrylate copolymer having pigment affinity groups), 2095 (a salt of a polyamide and a polyester), 2150 (an acrylate copolymer having basic pigment affinity groups), and 2155 (a block copolymer having pigment affinity groups);

ANTI-TERRA (a registered trademark)-U (a salt of a long-chain polyaminoamide and an acid ester), 203 (an alkylammonium salt of a polycarboxylic acid), and 204 (a polyaminoamide polycarboxylate), all manufactured by BYK Chemie GmbH;

the aforementioned BYK-P104 (an unsaturated polycarboxylic acid polymer), P104S and 220S (mixtures of a polysiloxane copolymer and a low-molecular weight unsaturated acidic polycarboxylic acid polyester), and 6919;

LACTIMON (a registered trademark) (a polysiloxane copolymer and a low-molecular weight unsaturated acidic polycarboxylic acid polyester), and LACTIMON-WS (a polysiloxane copolymer and an alkylolammonium salt of an unsaturated acidic polymer), both manufactured by BYK Chemie GmbH;

BYKUMEN (a registered trademark) (a low-molecular weight unsaturated polycarboxylic acid polyester) manufactured by BYK Chemie GmbH;

the SOLSPERSE series manufactured by Lubrizol Japan Ltd., including SOLSPERSE-3000, 9000, 13000, 13240, 13650, 13940, 16000, 17000, 18000, 20000, 21000, 24000, 26000, 27000, 28000, 31845, 32000, 32500, 32550, 33500, 32600, 34750, 35100, 36600, 38500, 41000, 41090, 53095, 55000 and 76500;

the EFKA series manufactured by BASF Corporation, including EFKA-46, 47, 48, 452, 4008, 4009, 4010, 4015, 4020, 4047, 4050, 4055, 4060, 4080, 4400, 4401, 4402, 4403, 4406, 4408, 4300, 4310, 4320, 4330, 4340, 450, 451, 453, 4540, 4550, 4560, 4800, 5010, 5065, 5066, 5070, 7500, 7554, 1101, 120, 150, 1501, 1502 and 1503; and

AJISPER (a registered trademark) PA111, PB711, PB821, PB822 and PB824 manufactured by Ajinomoto Fine-Techno Co., Inc.

When selecting the resin-type dispersant, the dispersant need not be limited to a single dispersant, and combinations of two or more dispersants may also be used.

By using the dispersant (D), the viscosity of the dispersed composition is less likely to increase, and the dispersion efficiency and the degree of blackness are more favorable. Further, provided the amount used of the dispersant (D) is not too large, foaming during dispersion is unlikely, the dispersion efficiency is good, and there is no deterioration in the blackness.

When a surfactant is used as the dispersant (D), the blend amount of the surfactant in the dispersed composition is not particularly limited, and varies depending on the varieties of the ultramarine (A) and the black inorganic pigment (B) and the variety of the surfactant, but the blend amount of the surfactant is preferably from 1 to 50% by weight, more preferably from 5 to 40% by weight, and still more preferably from 10 to 30% by weight, relative to the combined weight of the ultramarine (A) and the black inorganic pigment (B).

When a resin-type dispersant is used, the dispersant is preferably used in an amount of about 3 to 200% by weight relative to the combined weight of the ultramarine (A) and the black inorganic pigment (B), and from the viewpoint of film formability, is more preferably used in amount of about 5 to 100% by weight.

Various additives may be added to the dispersed composition in the present invention for the purpose of achieving better suitability as a composition or coating material. Specific examples of these additives include thickeners, pH modifiers, drying inhibitors, preservatives and fungicides, chelating agents, ultraviolet absorbers, antioxidants, antifoaming agents, rheology control agents, curing agents, and binder resins and the like.

If the dispersed composition of the present invention contains at least one of a binder resin (E) and a curing agent (F), then the composition can be used as a coating composition of the present invention. Further, a coating composition of the present invention may be obtained by adding a binder resin (E) and/or a curing agent (F) to the dispersed composition of the present invention.

Any of the various additives mentioned above may also be added to the coating composition of the present invention.

### <Binder Resin (E)>

Binder resins (E) that can be used in the present invention can be broadly classified into natural polymer resins and synthetic polymer resins, and there are no particular limitations on the resin used. Specific examples of the natural polymer resins include proteins such as nikawa glue, gelatin, casein and albumin, natural rubbers such as gum arabic, tragacanth rubber and xanthan rubber, glucosides such as saponin, alginic acid and alginic acid derivatives such as propylene glycol alginate, triethanolamine alginate and ammonium alginate, cellulose derivatives such as methyl cellulose, nitrocellulose, carboxymethyl cellulose, hydroxymethyl cellulose and ethyl hydroxy cellulose, and shellac resin.

Examples of the synthetic polymer resins include acrylic copolymers, styrene-acrylic acid-based copolymers, alkyd resins, epoxy resins, polyester resins, urethane resins, cellulose resins, polyvinylpyrrolidone resins, acrylic acid-acrylonitrile copolymers, acrylic potassium-acrylonitrile copolymers, vinyl acetate-acrylate ester copolymers, styrene-methacrylic acid copolymers, styrene-methacrylic acid-acrylate ester copolymers, styrene-a-methylstyrene-acrylic acid copolymers, styrene-a-methylstyrene-acrylic acid-acrylate ester copolymers, styrene-maleic anhydride copolymers, vinylnaphthalene-acrylic acid copolymers, vinylnaphthalene-maleic acid copolymers, vinyl acetate-ethylene copolymers, vinyl acetate-vinylethylene fatty acid copolymers, vinyl acetate-maleate ester copolymers, vinyl acetate-crotonic acid copolymers, vinyl acetate-acrylic acid copolymers, and salts of the above resins.

The binder resin is preferably an acrylic resin, urethane resin, epoxy resin, fiber-reinforced resin, fluororesin or acrylic emulsion or the like. Among these, an acrylic resin is particularly preferred. Examples of the acrylic resin include melamine-curable acrylic resins, self-cross-linking acrylic resins, polyisocyanate-curable acrylic resins, and moisture-curable silicon-acrylic resins, and specific examples include the DIANAL (a registered trademark) series manufactured by Mitsubishi Rayon Co., Ltd., the ACRYDIC (a registered trademark) series manufactured by DIC Corporation, and the HITALOID (a registered trademark) series manufactured by Hitachi Chemical Co., Ltd.

The binder resins (E) described above may be used individually, or combinations of two or more resins may be used, and although there are no particular limitations on the blend amount of the binder resin (E) within the dispersed composition, the blend amount is preferably from 2 to 5,000% by weight, and more preferably from 5 to 900% by weight, relative to the total weight of the ultramarine (A) and the black inorganic pigment (B).

Provided the blend amount of the binder resin (E) is not too large, satisfactory drying properties are obtained when the composition is coated onto a substrate such as a polyethylene terephthalate (PET) film, and undesirable Benard cells (drying irregularities) tend not to be formed on the coating film. On the other hand, provided the blend amount of the binder resin (E) is not too small, the adhesion to substrates such as polyethylene terephthalate (PET) films is favorable, and Benard cells are not formed on the coating film.

### <Curing Agent (F)>

Examples of curing agents (F) that can be used in the present invention include compounds that can react with the reactive functional groups of the resins within the dispersed composition of the present invention. Although dependent on the types of resins used, examples of the curing agent (F) include amino resins, polyisocyanate compounds, epoxy group-containing compounds, and carboxyl group-containing compounds.

Conventional dispersion devices can be used for the dispersion device used in preparing the dispersed composition and coating composition of the present invention, and although there are no particular limitations, examples of devices that can be used include a paint conditioner (manufactured by Red Devil Equipment Company), ball mill, sand mill (such as a “Dyno-Mill” manufactured by Shinmaru Enterprises Corporation), attritor, pearl mill (such as a “DCP mill” manufactured by Eirich Co., Ltd.), coball mill, basket mill, homomixer, sand grinder, Dispermat, SC mill, spike mill, Nanomizer, homogenizer (such as a “Clearmix” (a registered trademark) manufactured by M Technique Co, Ltd.), wet jet mill (such as a “Genus PY” manufactured by Genus Corporation, or a “Nanomizer” (a registered trademark) manufactured by Nanomizer Inc.). If cost and processing capacity are taken into consideration, then the use of a media-type dispersion device is preferable. Examples of media that can be used include glass beads, zirconia beads, alumina beads, magnetic beads, stainless beads, plastic beads, and titania beads. The dispersed composition may be produced in a single batch with all of the pigments, or a separate pigment dispersion may be produced for each pigment, and these separate dispersions then mixed together.

Conventional methods can be used for mixing the dispersed composition with the binder resin (E) and/or the curing agent (F). For example, the binder resin may be added while the dispersed composition is stirred using a Dispermat. Further, the binder resin (E) and/or the curing agent (F) may be added and dispersed following the preparation of the dispersed composition.

There are no particular limitations on the applications of the coating composition of the present invention, and the coating composition can be used in applications which require a high surface resistivity, such as color filter applications used in any of various displays, or automotive applications. Further, the coating composition of the present invention can also be used in applications which require infrared permeability, such as heat-shielding coating materials. In the case of a heat-shielding coating material, the infrared radiation irradiated onto the coating film and the infrared radiation reflected by the coated item (also called the substrate) are not stored as heat within the coating film, but rather is transmitted through the coating film, meaning overheating of the coated item can be suppressed.

A coating film of the present invention is formed by applying the aforementioned coating composition of the present invention to a substrate, performing appropriate drying, and then heating if necessary.

From the viewpoint of the insulation properties, the surface resistivity of the coating film is preferably at least 10⁷ Ω/square, and more preferably 10¹⁰ Ω/square or greater.

Further, in terms of obtaining a favorable combination of blackness and infrared permeability, the lightness (L value) of the coating film is preferably not more than 24, and more preferably 22 or more. The lightness (L value) indicates the degree of brightness or darkness of a color, and if the lightness is low, then the reflectivity is low and the degree of darkness is higher.

A colored item of the present invention preferably has a coating film of the present invention formed from a coating composition of the present invention on a substrate. Specifically, the coating film (also called a colored layer) is formed by applying the coating composition of the present invention to the substrate.

The substrate is preferably a metal, wood, glass or resin material, or may be a laminate of these materials. The resin may be a natural resin or a synthetic resin. Further, the shape of the substrate may be plate-like, film-like, sheet-like, or a molded form. The molded form can be produced using any of various molding methods, including injection molding methods such as the insert injection molding method, in-mold molding method, over-mold molding method, two-color injection molding method, core-back injection molding method and sandwich injection molding method, extrusion molding methods such as the T-die laminate molding method, multilayer inflation molding method, co-extrusion molding method and extrusion coating method, as well as other molding methods such as the multilayer blow molding method, multilayer calender molding method, multilayer press molding method, slush molding method and melt casting method.

Examples of metals that can be used as the substrate include copper, iron, aluminum, stainless steel, alloys containing these metals, or plated metal sheets such as zinc-plated steel sheets or aluminum-zinc-plated steel sheets. Further, among the above resins, examples of the synthetic resins include polypropylene resins, acrylic resins, urethane resins, epoxy resins, fiber-reinforced resins and fluororesins.

For the coating method, a conventional method can be used using dipping, a brush, roller, roll coater, air spraying, airless spraying, curtain flow coater, roller curtain coater, or die coater or the like. The thickness of the colored layer is preferably from 1 to 50

The substrate in the present invention is preferably a substrate that is capable of reflecting infrared radiation. This is preferable in terms of the blackness of the colored layer, and in terms of effectively generating the functions of weather resistance and infrared permeability. Specifically, a material formed from a compound that reflects infrared radiation, such as a resin containing titanium dioxide which readily adopts a white color, or a material on which a coating film containing such a compound has been formed, is preferable.

The titanium dioxide is preferably of the rutile-type or anatase-type, and is preferably capable of reflecting infrared radiation. Further, in order to suppress surface activity, the titanium dioxide is preferably surface-treated with an inorganic material or an organic material.

### EXAMPLES

The present invention is described below in further detail using a series of examples, but the present invention is in no way limited by the examples. In the examples, unless specifically stated otherwise, the units “parts” and “%” indicate “parts by weight” and “% by weight” respectively. The amounts used of the dispersants and binder resins used in the production of the dispersed compositions and the coating compositions in the examples indicate the actual amounts added, whereas the net amounts of the dispersants and the resins indicate the amount multiplied by the respective non-volatile fraction.

### Example Group A

First is a description of Example Group A, in which water was used as the dispersion medium. The materials used in Examples 1 to 168 and Comparative Examples 1 to 32 in Example Group A are listed below.

### <Pigments>

Ultramarine A: Gunjo 8600P (C.I. Pigment Blue 29, manufactured by Daiichi Kasei Kogyo Co., Ltd., D50 average particle size: 0.6 μm, D99 average particle size: 1.6 composition: 62% as Na₆(Al₆Si₆O₂₄).2NaS₃). Blend amounts of the ultramarine A mentioned below refer to the amount of Na₆(Al₆Si₆O₂₄).2NaS₃.
Ultramarine B: Nubix G58 (C.I. Pigment Blue 29, manufactured by Nubiola, D50 average particle size: 0.7 μm, D99 average particle size: 1.8 μm, composition: >99% as Na₆(Al₆Si₆O₂₄).2NaS₃)
Ultramarine C: Nubix EP62 (C.I. Pigment Blue 29, manufactured by Nubiola, D50 average particle size: 0.5 μm, D99 average particle size: 1.6 μm, composition: >99% as Na₆(Al₆Si₆O₂₄).2NaS₃)
Black inorganic pigment A: BAYFERROX (a registered trademark) 303T (C.I. Pigment Black 33, manufactured by LANXESS AG, D50 average particle size: 0.6 μm, D99 average particle size: 1.6 μm, composition: 77.2% as Fe₃O₄, 22% as MnO)
Black inorganic pigment B: BAYFERROX 360 (C.I. Pigment Black 11, manufactured by LANXESS AG, D50 average particle size: 0.7 μm, D99 average particle size: 1.7 μm, composition: >99% as Fe₃O₄)
Black inorganic pigment C: TAROX BL-100 (C.I. Pigment Black 11, manufactured by Titan Kogyo, Ltd., composition: >99% as Fe₃O₄)
Phthalocyanine blue A: LIONOL (a registered trademark) Blue NCB Toner (C.I. Pigment Blue 15:3, manufactured by Toyochem Co., Ltd.)
Carbon black A: Raven (a registered trademark) 420 (C.I. Pigment Black 7, manufactured by Columbian Carbon Company)
Perylene black A: PALIOGEN (a registered trademark) Black 50084 (C.I. Pigment Black 31, manufactured by BASF Corporation, D50 average particle size: 0.1 μm, D99 average particle size: 0.3 μm)

### <Dispersant (D)>

Dispersant A: KAOCER (a registered trademark) 8200 (a nonionic surfactant, manufactured by Kao Corporation)
Dispersant B: KAOCER 8000 (an anionic surfactant, manufactured by Kao Corporation)

### <Dispersion Medium (C)>

Water

### <Binder Resin (E)>

WATERSOL (a registered trademark)S-695 (an acrylic resin, manufactured by DIC Corporation)

### <Other>

Extender pigment: Sunlite SL-1000 (manufactured by Shiraishi Kogyo Kaisha, Ltd.)
Preservative: Levanax MIT-50 (manufactured by Shoei Chemical Co., Ltd.)

### <Method of Measuring Average Particle Size>

The method used for measuring the D50 average particle size and the D99 average particle size values for the ultramarines and the black inorganic pigments used in the examples is described below.

| | |
|---|---|
| Ultramarine or black inorganic pigment | 40.00 g |
| BYK110 | 3.85 g |
| DIANAL AR-2912 | 14.29 g |
| Butyl acetate | 20.93 g |
| Methyl isobutyl ketone | 20.93 g |

(BYK110 is a resin-type dispersant manufactured by BYK Chemie GmbH, and DIANAL AR-2912 is a registered trademark for an acrylic resin manufactured by Mitsubishi Rayon Co., Ltd.)

The above components were placed in a beads mill dispersion device (Dyno-Mill KDL) together with Unibeads (a registered trademark for glass beads manufactured by Unitika Ltd.) UB2022S, and dispersion was performed under conditions including a fill factor of 80%, a circumferential speed of 10 m/second, a discharge rate of 300 to 500 g/minute, and a residence time of 15 minutes, thus obtaining a dispersed composition.

Subsequently, the obtained dispersed composition was diluted 10 times by weight with butyl acetate to obtain a sample solution. Butyl acetate was placed in the sample cell section of a dynamic light scattering particle size and particle size distribution measuring device (Nanotrac (a registered trademark) NPA150, manufactured by Nikkiso Co., Ltd.), and two drops of the above sample solution were then added to ensure that the reflected light power was within the measurement range. The refractive index of the butyl acetate of the measurement medium was set to 1.394, and the viscosity was set to 0.734 cP. When the particles being measured were an ultramarine, the measurement was performed with settings for light-permeable particles with a refractive index of 1.81, an amorphous shape and a density of 2.35 g/cm³, whereas when the particles being measured were a black inorganic pigment, measurement was performed with settings for light-absorbing particles with an amorphous shape and a density of 5.117 g/cm³. Following measurement, particles in the obtained particle size distribution were counted starting at the smallest particles, and the particle size at the point when 50% of all the particles had been counted (50% by number) was recorded as the D50 average particle size, and the particle size at the point when 99% of all the particles had been counted (99% by number) was recorded as the D99 average particle size. A single sample solution was measured three times, and the average values of the three measurements were recorded as the respective average particle sizes.

<Dispersed Composition Preparation-1>

### Example 1

| | |
|---|---|
| Ultramarine A | 24.6 parts by weight |
| Black inorganic pigment A | 6.0 parts by weight |
| Dispersant A | 7.5 parts by weight |
| Dispersant B | 0.5 parts by weight |
| Extender pigment | 1.0 parts by weight |
| Preservative | 0.5 parts by weight |
| Water | 59.9 parts by weight |

The above components were placed in a beads mill dispersion device (Dyno-Mill KDL) together with Unibeads (a registered trademark for glass beads manufactured by Unitika Ltd.) UB2022S, and dispersion was performed under conditions including a fill factor of 80%, a circumferential speed of 10 m/second, a discharge rate of 300 to 500 g/minute, and a residence time of 15 minutes, thus obtaining a dispersed composition 1.

### Examples 2 to 42, Comparative Examples 1 to 7

With the exception of replacing the components used in Example 1 with the components and blend ratios shown in Tables 1 and 2, dispersed compositions 2 to 49 were obtained in the same manner as Example 1. The dispersed compositions and the ratios (weight ratios) of the pigments contained within those compositions are shown in Tables 1 and 2.

TABLE 1

| | | | | | Pigment 2 | | | | | | | | |
|---|---|---|---|---|---|---|---|---|---|---|---|---|---|
| | | | | | (black | | | | | | | | Dispersion |
| | | | | | inorganic | | Pigment | | | Dis- | Extender | Preser- | medium |
| | | Dispersed | Pigment 1 | | pigment) | | weight ratio | | Dispersant A | persant B | pigment | vative | (water) |
| | | composition | type | parts | type | parts | Pigment 1 | Pigment 2 | parts | parts | parts | parts | parts |
| Exam- | 1 | 1 | Ultramarine A | 24.6 | A | 6.0 | 80.4 | 19.6 | 7.5 | 0.5 | 1.0 | 0.5 | 59.9 |
| ple | 2 | 2 | Ultramarine A | 21.8 | A | 12.0 | 64.5 | 35.5 | 6.6 | 1.0 | 2.0 | 0.5 | 56.1 |
| | 3 | 3 | Ultramarine A | 19.1 | A | 18.0 | 51.5 | 48.5 | 5.8 | 1.5 | 3.0 | 0.5 | 52.1 |
| | 4 | 4 | Ultramarine B | 19.1 | A | 18.0 | 51.5 | 48.5 | 5.8 | 1.5 | 3.0 | 0.5 | 52.1 |
| | 5 | 5 | Ultramarine C | 19.1 | A | 18.0 | 51.5 | 48.5 | 5.8 | 1.5 | 3.0 | 0.5 | 52.1 |
| | 6 | 6 | Ultramarine A | 13.7 | A | 30.0 | 31.4 | 68.6 | 4.2 | 2.5 | 5.0 | 0.5 | 44.1 |
| | 7 | 7 | Ultramarine B | 13.7 | A | 30.0 | 31.4 | 68.6 | 4.2 | 2.5 | 5.0 | 0.5 | 44.1 |
| | 8 | 8 | Ultramarine C | 13.7 | A | 30.0 | 31.4 | 68.6 | 4.2 | 2.5 | 5.0 | 0.5 | 44.1 |
| | 9 | 9 | Ultramarine A | 8.2 | A | 42.0 | 16.3 | 83.7 | 2.5 | 3.5 | 7.0 | 0.5 | 36.3 |
| | 10 | 10 | Ultramarine B | 8.2 | A | 42.0 | 16.3 | 83.7 | 2.5 | 3.5 | 7.0 | 0.5 | 36.3 |
| | 11 | 11 | Ultramarine C | 8.2 | A | 42.0 | 16.3 | 83.7 | 2.5 | 3.5 | 7.0 | 0.5 | 36.3 |
| | 12 | 12 | Ultramarine A | 2.7 | A | 54.0 | 4.8 | 95.2 | 0.8 | 4.5 | 9.0 | 0.5 | 28.5 |
| | 13 | 13 | Ultramarine B | 2.7 | A | 54.0 | 4.8 | 95.2 | 0.8 | 4.5 | 9.0 | 0.5 | 28.5 |
| | 14 | 14 | Ultramarine C | 2.7 | A | 54.0 | 4.8 | 95.2 | 0.8 | 4.5 | 9.0 | 0.5 | 28.5 |
| | 15 | 15 | Ultramarine A | 24.6 | B | 6.0 | 80.4 | 19.6 | 7.5 | 0.5 | 1.0 | 0.5 | 59.9 |
| | 16 | 16 | Ultramarine A | 21.8 | B | 12.0 | 64.5 | 35.5 | 6.6 | 1.0 | 2.0 | 0.5 | 56.1 |
| | 17 | 17 | Ultramarine A | 19.1 | B | 18.0 | 51.5 | 48.5 | 5.8 | 1.5 | 3.0 | 0.5 | 52.1 |
| | 18 | 18 | Ultramarine B | 19.1 | B | 18.0 | 51.5 | 48.5 | 5.8 | 1.5 | 3.0 | 0.5 | 52.1 |
| | 19 | 19 | Ultramarine C | 19.1 | B | 18.0 | 51.5 | 48.5 | 5.8 | 1.5 | 3.0 | 0.5 | 52.1 |
| | 20 | 20 | Ultramarine A | 13.7 | B | 30.0 | 31.4 | 68.6 | 4.2 | 2.5 | 5.0 | 0.5 | 44.1 |
| | 21 | 21 | Ultramarine B | 13.7 | B | 30.0 | 31.4 | 68.6 | 4.2 | 2.5 | 5.0 | 0.5 | 44.1 |
| | 22 | 22 | Ultramarine C | 13.7 | B | 30.0 | 31.4 | 68.6 | 4.2 | 2.5 | 5.0 | 0.5 | 44.1 |
| | 23 | 23 | Ultramarine A | 8.2 | B | 42.0 | 16.3 | 83.7 | 2.5 | 3.5 | 7.0 | 0.5 | 36.3 |
| | 24 | 24 | Ultramarine B | 8.2 | B | 42.0 | 16.3 | 83.7 | 2.5 | 3.5 | 7.0 | 0.5 | 36.3 |
| | 25 | 25 | Ultramarine C | 8.2 | B | 42.0 | 16.3 | 83.7 | 2.5 | 3.5 | 7.0 | 0.5 | 36.3 |
| | 26 | 26 | Ultramarine A | 2.7 | B | 54.0 | 4.8 | 95.2 | 0.8 | 4.5 | 9.0 | 0.5 | 28.5 |
| | 27 | 27 | Ultramarine B | 2.7 | B | 54.0 | 4.8 | 95.2 | 0.8 | 4.5 | 9.0 | 0.5 | 28.5 |
| | 28 | 28 | Ultramarine C | 2.7 | B | 54.0 | 4.8 | 95.2 | 0.8 | 4.5 | 9.0 | 0.5 | 28.5 |

TABLE 2

| | | | | | Pigment 2 | | | | | | | | |
|---|---|---|---|---|---|---|---|---|---|---|---|---|---|
| | | | | | (black | | | | | | | | Dispersion |
| | | Dispersed | | | inorganic | | Pigment | | Dis- | Dis- | Extender | Preser- | medium |
| | | com- | Pigment 1 | | pigment) | | weight ratio | | persant A | persant B | pigment | vative | (water) |
| | | position | type | parts | type | parts | Pigment 1 | Pigment 2 | parts | parts | parts | parts | parts |
| Example | 29 | 29 | Ultramarine A | 24.6 | C | 6.0 | 80.4 | 19.6 | 7.5 | 0.5 | 1.0 | 0.5 | 59.9 |
| | 30 | 30 | Ultramarine A | 21.8 | C | 12.0 | 64.5 | 35.5 | 6.6 | 1.0 | 2.0 | 0.5 | 56.1 |
| | 31 | 31 | Ultramarine A | 19.1 | C | 18.0 | 51.5 | 48.5 | 5.8 | 1.5 | 3.0 | 0.5 | 52.1 |
| | 32 | 32 | Ultramarine B | 19.1 | C | 18.0 | 51.5 | 48.5 | 5.8 | 1.5 | 3.0 | 0.5 | 52.1 |
| | 33 | 33 | Ultramarine C | 19.1 | C | 18.0 | 51.5 | 48.5 | 5.8 | 1.5 | 3.0 | 0.5 | 52.1 |
| | 34 | 34 | Ultramarine A | 13.7 | C | 30.0 | 31.4 | 68.6 | 4.2 | 2.5 | 5.0 | 0.5 | 44.1 |
| | 35 | 35 | Ultramarine B | 13.7 | C | 30.0 | 31.4 | 68.6 | 4.2 | 2.5 | 5.0 | 0.5 | 44.1 |
| | 36 | 36 | Ultramarine C | 13.7 | C | 30.0 | 31.4 | 68.6 | 4.2 | 2.5 | 5.0 | 0.5 | 44.1 |
| | 37 | 37 | Ultramarine A | 8.2 | C | 42.0 | 16.3 | 83.7 | 2.5 | 3.5 | 7.0 | 0.5 | 36.3 |
| | 38 | 38 | Ultramarine B | 8.2 | C | 42.0 | 16.3 | 83.7 | 2.5 | 3.5 | 7.0 | 0.5 | 36.3 |
| | 39 | 39 | Ultramarine C | 8.2 | C | 42.0 | 16.3 | 83.7 | 2.5 | 3.5 | 7.0 | 0.5 | 36.3 |
| | 40 | 40 | Ultramarine A | 2.7 | C | 54.0 | 4.8 | 95.2 | 0.8 | 4.5 | 9.0 | 0.5 | 28.5 |
| | 41 | 41 | Ultramarine B | 2.7 | C | 54.0 | 4.8 | 95.2 | 0.8 | 4.5 | 9.0 | 0.5 | 28.5 |
| | 42 | 42 | Ultramarine C | 2.7 | C | 54.0 | 4.8 | 95.2 | 0.8 | 4.5 | 9.0 | 0.5 | 28.5 |
| Com- | 1 | 43 | Ultramarine B | 37.1 | — | — | 100 | 0 | 5.8 | 1.5 | 3.0 | 0.5 | 52.1 |
| parative | 2 | 44 | — | 37.1 | A | — | 0 | 100 | 5.8 | 1.5 | 3.0 | 0.5 | 52.1 |
| example | 3 | 45 | — | 37.1 | B | — | 0 | 100 | 5.8 | 1.5 | 3.0 | 0.5 | 52.1 |
| | 4 | 46 | — | 37.1 | C | — | 0 | 100 | 5.8 | 1.5 | 3.0 | 0.5 | 52.1 |
| | 5 | 47 | Phthalocyanine | 19.1 | A | 18.0 | 51.5 | 48.5 | 5.8 | 1.5 | 3.0 | 0.5 | 52.1 |
| | | | blue A | | | | | | | | | | |
| | 6 | 48 | Carbon black A | 37.1 | — | — | 100 | 0 | 5.8 | 1.5 | 3.0 | 0.5 | 52.1 |
| | 7 | 49 | Perylene black A | 37.1 | — | — | 100 | 0 | 5.8 | 1.5 | 3.0 | 0.5 | 52.1 |

### Coating Composition Preparation-1

### Example 43

The binder resin was blended into the dispersed composition 1 described in Example 1 in an amount of 20 parts by weight of the binder resin per 100 parts by weight of the dispersed composition (hereafter described as 20 PHR), thus obtaining a coating composition 1.

### Examples 44 to 84

With the exception of using the dispersed compositions 2 to 42 instead of the dispersed composition 1, coating compositions 2 to 42 were obtained in the same manner as Example 43.

### Comparative Example 8

The binder resin was blended in an amount of 20 PHR into the dispersed composition 43 obtained in Comparative Example 1 to obtain a coating composition 43.

### Comparative Examples 9 to 14

With the exception of using the dispersed compositions 44 to 49 instead of the dispersed composition 43, coating compositions 44 to 49 were obtained in the same manner as Comparative Example 8.

### Coating Film Preparation-1

### Example 85

The coating composition 1 obtained in Example 43 was applied to a polyethylene terephthalate (PET) film having a thickness of 100 μm using a 7 mil applicator (1 mil=about 25.4 μm, resulting in an applied film thickness of 180 to 200 μm), and the applied composition was then dried to obtain a coating film 1. The drying conditions involved drying at 25° C. for 10 minutes, then at 60° C. for 5 minutes, and subsequently at 140° C. for 20 minutes.

### Examples 86 to 126

With the exception of using the coating compositions 2 to 42 instead of the coating composition 1, coating films 2 to 42 were obtained in the same manner as Example 85.

### Comparative Examples 15 to 21

With the exception of using the coating compositions 43 to 49 obtained in Comparative Examples 8 to 14 instead of the coating composition 1, coating films 43 to 49 were obtained in the same manner as Example 85.

The thickness of each of the coating films 1 to 49 described above was within a range from 180 to 200 μm.

### Colored Item Preparation-1

### Example 127

The coating composition 1 obtained in Example 43 was applied to a metal sheet made of stainless steel using a spray gun (manufactured by Anest Iwata Corporation), and the composition was then dried naturally to obtain a colored item 1.

### Examples 128 to 168

With the exception of using the coating compositions 2 to 42 instead of the coating composition 1, colored items 2 to 42 were obtained in the same manner as Example 127.

### Comparative Examples 22 to 28

With the exception of using the coating compositions 43 to 49 instead of the coating composition 1, colored items 43 to 49 were obtained in the same manner as Example 127.

The method used for evaluating the storage stability of the dispersed compositions and the coating compositions is described below, and the evaluation results are shown in Table 3 and Table 4.

### Method of Measuring and Evaluating Storage Stability

The storage stability was evaluated by leaving the composition to stand for one week, either at room temperature or 50° C., and then inspecting the composition visually and evaluating the storage stability against the 4-grade scale listed below.

A: no separation or precipitation.

B: some slight separation and precipitation is observed, but gentle stirring returns the composition to its original state.

C: some separation and precipitation.

D: considerable separation and precipitation.

TABLE 3

| | | Dispersed | Storage stability |
|---|---|---|---|
| | | composition | (50° C.) |
| Example | 1 | 1 | A |
| | 2 | 2 | A |
| | 3 | 3 | A |
| | 4 | 4 | A |
| | 5 | 5 | A |
| | 6 | 6 | A |
| | 7 | 7 | A |
| | 8 | 8 | A |
| | 9 | 9 | A |
| | 10 | 10 | A |
| | 11 | 11 | A |
| | 12 | 12 | A |
| | 13 | 13 | A |
| | 14 | 14 | A |
| | 15 | 15 | A |
| | 16 | 16 | A |
| | 17 | 17 | A |
| | 18 | 18 | A |
| | 19 | 19 | A |
| | 20 | 20 | A |
| | 21 | 21 | A |
| | 22 | 22 | A |
| | 23 | 23 | A |
| | 24 | 24 | A |
| | 25 | 25 | A |
| | 26 | 26 | A |
| | 27 | 27 | A |
| | 28 | 28 | A |
| | 29 | 29 | A |
| | 30 | 30 | A |
| | 31 | 31 | A |
| | 32 | 32 | A |
| | 33 | 33 | A |
| | 34 | 34 | A |
| | 35 | 35 | A |
| | 36 | 36 | A |
| | 37 | 37 | A |
| | 38 | 38 | A |
| | 39 | 39 | A |
| | 40 | 40 | A |
| | 41 | 41 | A |
| | 42 | 42 | A |
| Comparative | 1 | 43 | A |
| Example | 2 | 44 | A |
| | 3 | 45 | A |
| | 4 | 46 | A |
| | 5 | 47 | D |
| | 6 | 48 | A |
| | 7 | 49 | D |

TABLE 4

| | | Coating | Storage stability |
|---|---|---|---|
| | | composition | (50° C.) |
| Example | 43 | 1 | A |
| | 44 | 2 | A |
| | 45 | 3 | A |
| | 46 | 4 | A |
| | 47 | 5 | A |
| | 48 | 6 | A |
| | 49 | 7 | A |
| | 50 | 8 | A |
| | 51 | 9 | A |
| | 52 | 10 | A |
| | 53 | 11 | A |
| | 54 | 12 | A |
| | 55 | 13 | A |
| | 56 | 14 | A |
| | 57 | 15 | A |
| | 58 | 16 | A |
| | 59 | 17 | A |
| | 60 | 18 | A |
| | 61 | 19 | A |
| | 62 | 20 | A |
| | 63 | 21 | A |
| | 64 | 22 | A |
| | 65 | 23 | A |
| | 66 | 24 | A |
| | 67 | 25 | A |
| | 68 | 26 | A |
| | 69 | 27 | A |
| | 70 | 28 | A |
| | 71 | 29 | A |
| | 72 | 30 | A |
| | 73 | 31 | A |
| | 74 | 32 | A |
| | 75 | 33 | A |
| | 76 | 34 | A |
| | 77 | 35 | A |
| | 78 | 36 | A |
| | 79 | 37 | A |
| | 80 | 38 | A |
| | 81 | 39 | A |
| | 82 | 40 | A |
| | 83 | 41 | A |
| | 84 | 42 | A |
| Comparative | 8 | 43 | A |
| Example | 9 | 44 | B |
| | 10 | 45 | B |
| | 11 | 46 | B |
| | 12 | 47 | D |
| | 13 | 48 | A |
| | 14 | 49 | D |

The methods used for evaluating the surface resistivity, the weather resistance and the degree of blackness (the lightness and a visual evaluation) of the coating films and the colored items are described below. The evaluation results are shown in Tables 5 and 6.

### <Method of Measuring and Evaluating Surface Resistivity>

Measurement of the surface resistivity of the coating films and the colored items was performed using an ammeter (Digital Electrometer TR-8652, manufactured by ADC

Corporation) and an ultra high resistance-measuring sample chamber having an annular electrode (Chamber TR42, manufactured by ADC Corporation). The annular electrode was set on the coating film, and measurement was performed for a measurement time of 60 seconds using an applied voltage of 1.0 V. The surface resistivity was calculated from the obtained resistance value Rx using a formula 1 shown below.

The surface resistivity was evaluated against the 4-grade scale listed below.

A: 10¹⁰ Ω/square or greater (extremely superior)

B: 10⁷ to 10⁹ Ω/square (superior)

C: 10⁵ to 10⁶ Ω/square (slightly poor)

D: 10⁴ Ω/square or less (extremely poor)

Surface Resistivity≈18.84×Rx[Ω] [Formula 1]

Rx: measured value using TR8652 and VSRM

### <Method of Measuring and Evaluating Weather Resistance>

The weather resistance of the coating films and the colored items was measured by irradiating the surface of the coating film for 2,000 hours using a xenon long-life weather meter (WEL75X-HC•B•EC•S, manufactured by Suga Test Instruments Co., Ltd.). Using a Color Meter (SE2000, manufactured by Nippon Denshoku Industries Co., Ltd.), the hue of the surface of the coating film was measured before irradiation and then after irradiation of the coating film for 2,000 hours, and the weather resistance was then evaluated using the hue difference calculated from a formula 2 shown below. The measurements were performed using a D65 light source, and the measurement wavelength range was from 380 nm to 780 nm.

The weather resistance was evaluated against the 4-grade scale for the hue difference listed below. A small difference in the hue indicates favorable weather resistance.

A: less than 1.0 (no degradation of the coating film is noticeable)

B: at least 1.0, but less than 3.0 (slight degradation of the coating film is noticeable, but of no problem from a practical perspective)

C: at least 3.0, but less then 5.0 (some degradation of the coating film is visible)

D: 5.0 or greater (considerable degradation of the coating film is visible)

Hue difference={square root over (((L₂−L₁)²+(a₂−a₁)²+(b₂−b₁)²))} [Formula 2]

L₁: lightness of the coating film surface before irradiation

L₂: lightness of the coating film surface after irradiation

a₁: red/green index of the coating film surface before irradiation

a₂: red/green index of the coating film surface after irradiation

b₁: yellow/blue index of the coating film surface before irradiation

b₂: yellow/blue index of the coating film surface after irradiation

### <Method of Measuring and Evaluating Lightness (L Value)>

The lightness of the coating films and the colored items was measured using a Spectro Color Meter (SQ-2000, manufactured by Nippon Denshoku Industries Co., Ltd.), by measuring the lightness (L value) from the surface of the coating film. The measurements were performed using a D65 light source, and the measurement wavelength range was from 380 nm to 780 nm.

The lightness was evaluated against the 4-grade scale listed below. A lower lightness indicates lower reflectivity and superior blackness.

A: 22.0 or less (extremely superior blackness)

B: 22.1 to 24.0 (superior blackness)

C: 24.1 to 26.0 (slightly inferior blackness)

D: 26.1 or greater (extremely inferior blackness)

### <Visual Evaluation Method>

A visual test was performed by inspecting each coating film visually, and evaluating the degree of blackness against the 4-grade scale listed below.

A: extremely superior blackness

B: superior blackness

C: slightly inferior blackness

D: extremely inferior blackness

TABLE 5

| | | | | | | Visual |
|---|---|---|---|---|---|---|
| | | Coating | Surface | Weather | Light- | eval- |
| | | film | resistivity | resistance | ness | uation |
| Example | 85 | 1 | A | A | B | B |
| | 86 | 2 | A | A | A | A |
| | 87 | 3 | A | A | A | A |
| | 88 | 4 | A | A | A | A |
| | 89 | 5 | A | A | A | A |
| | 90 | 6 | A | A | A | A |
| | 91 | 7 | A | A | A | A |
| | 92 | 8 | A | A | A | A |
| | 93 | 9 | A | A | B | A |
| | 94 | 10 | A | A | B | A |
| | 95 | 11 | A | A | B | A |
| | 96 | 12 | A | A | B | B |
| | 97 | 13 | A | A | B | B |
| | 98 | 14 | A | A | B | B |
| | 99 | 15 | A | A | B | B |
| | 100 | 16 | A | A | A | A |
| | 101 | 17 | A | A | A | A |
| | 102 | 18 | A | A | A | A |
| | 103 | 19 | A | A | A | A |
| | 104 | 20 | A | A | A | A |
| | 105 | 21 | A | A | A | A |
| | 106 | 22 | A | A | A | A |
| | 107 | 23 | A | A | B | B |
| | 108 | 24 | A | A | B | B |
| | 109 | 25 | A | A | B | B |
| | 110 | 26 | A | A | B | B |
| | 111 | 27 | A | A | B | B |
| | 112 | 28 | A | A | B | B |
| | 113 | 29 | A | A | B | B |
| | 114 | 30 | A | A | A | B |
| | 115 | 31 | A | A | A | A |
| | 116 | 32 | A | A | A | A |
| | 117 | 33 | A | A | A | A |
| | 118 | 34 | A | A | A | A |
| | 119 | 35 | A | A | A | A |
| | 120 | 36 | A | A | A | A |
| | 121 | 37 | A | A | B | B |
| | 122 | 38 | A | A | B | B |
| | 123 | 39 | A | A | B | B |
| | 124 | 40 | A | A | B | B |
| | 125 | 41 | A | A | B | B |
| | 126 | 42 | A | A | B | B |
| Comparative | 15 | 43 | B | A | D | D |
| Example | 16 | 44 | B | C | B | B |
| | 17 | 45 | B | C | B | B |
| | 18 | 46 | B | C | B | C |
| | 19 | 47 | D | C | B | B |
| | 20 | 48 | D | B | A | B |
| | 21 | 49 | C | D | D | C |

TABLE 6

| | | | | | | Visual |
|---|---|---|---|---|---|---|
| | | Colored | Surface | Weather | Light- | eval- |
| | | item | resistivity | resistance | ness | uation |
| Example | 127 | 1 | A | A | B | B |
| | 128 | 2 | A | A | A | A |
| | 129 | 3 | A | A | A | A |
| | 130 | 4 | A | A | A | A |
| | 131 | 5 | A | A | A | A |
| | 132 | 6 | A | A | A | A |
| | 133 | 7 | A | A | A | A |
| | 134 | 8 | A | A | A | A |
| | 135 | 9 | A | A | B | A |
| | 136 | 10 | A | A | B | A |
| | 137 | 11 | A | A | B | A |
| | 138 | 12 | A | A | B | B |
| | 139 | 13 | A | A | B | B |
| | 140 | 14 | A | A | B | B |
| | 141 | 15 | A | A | B | B |
| | 142 | 16 | A | A | A | A |
| | 143 | 17 | A | A | A | A |
| | 144 | 18 | A | A | A | A |
| | 145 | 19 | A | A | A | A |
| | 146 | 20 | A | A | A | A |
| | 147 | 21 | A | A | A | A |
| | 148 | 22 | A | A | A | A |
| | 149 | 23 | A | A | B | B |
| | 150 | 24 | A | A | B | B |
| | 151 | 25 | A | A | B | B |
| | 152 | 26 | A | A | B | B |
| | 153 | 27 | A | A | B | B |
| | 154 | 28 | A | A | B | B |
| | 155 | 29 | A | A | B | B |
| | 156 | 30 | A | A | A | B |
| | 157 | 31 | A | A | A | A |
| | 158 | 32 | A | A | A | A |
| | 159 | 33 | A | A | A | A |
| | 160 | 34 | A | A | A | A |
| | 161 | 35 | A | A | A | A |
| | 162 | 36 | A | A | A | A |
| | 163 | 37 | A | A | B | B |
| | 164 | 38 | A | A | B | B |
| | 165 | 39 | A | A | B | B |
| | 166 | 40 | A | A | B | B |
| | 167 | 41 | A | A | B | B |
| | 168 | 42 | A | A | B | B |
| Comparative | 22 | 43 | B | A | D | D |
| Example | 23 | 44 | B | C | B | B |
| | 24 | 45 | B | C | B | B |
| | 25 | 46 | B | C | B | C |
| | 26 | 47 | D | C | B | B |
| | 27 | 48 | D | B | A | B |
| | 28 | 49 | C | D | D | C |

As is evident from Examples 1 to 168 and Comparative Examples 1 to 28, the coating films and the colored items which used the dispersed compositions of the present invention exhibited superior results, with no problems of a practical level, in all the evaluation results for surface resistivity, weather resistance and degree of blackness (lightness and the visual evaluation). In contrast, it was clear that the coating films of Comparative Example 15 and 21 and the colored items of Comparative Examples 22 and 28 exhibited inferior blackness. Further, it was also clear that the coating films of Comparative Examples 19 and 20 and the colored items of Comparative Examples 26 and 27 exhibited inferior surface resistivity. Furthermore, in the coating films of Comparative Examples 16 to 18 and the colored items of Comparative Examples 23 to 25, some slight degradation of the coating film was observed, indicating inferior weather resistance.

The materials used in Examples 201 to 422 and Comparative Examples 201 to 405 in Example Group A are listed below.

### <Pigments>

Ultramarine A: Gunjo 8600P (as described above, C.I. Pigment Blue 29, manufactured by Daiichi Kasei Kogyo Co., Ltd., D50 average particle size: 0.6 rim, D99 average particle size: 1.6 μm, composition: 62% as Na₆(Al₆Si₆O₂₄).2NaS₃)
Ultramarine B: Nubix G58 (as described above, C.I. Pigment Blue 29, manufactured by Nubiola, D50 average particle size: 0.7 μm, D99 average particle size: 1.8 μm, composition: >99% as Na₆(Al₆Si₆O₂₄).2NaS₃)
Ultramarine C: Nubix EP62 (as described above, C.I. Pigment Blue 29, manufactured by Nubiola, D50 average particle size: 0.5 μm, D99 average particle size: 1.6 μm, composition: >99% as Na₆(Al₆Si₆O₂₄).2NaS₃)
Black inorganic pigment A: BAYFERROX 303T (as described above, C.I. Pigment Black 33, manufactured by LANXESS AG, D50 average particle size: 0.6 μm, D99 average particle size: 1.6 μm, composition: 77.2% as Fe₃O₄, 22% as MnO)
Black inorganic pigment B: BAYFERROX 360 (as described above, C.I. Pigment Black 11, manufactured by LANXESS AG, D50 average particle size: 0.7 μm, D99 average particle size: 1.7 μm, composition: >99% as Fe₃O₄)
Perylene black A: PALIOGEN BLACK 50084 (as described above, C.I. Pigment Black 31, manufactured by BASF Corporation, D50 average particle size: 0.1 μm, D99 average particle size: 0.3 μm)
Carbon black B: #45 (manufactured by Mitsubishi Chemical Corporation, D50 average particle size: 0.02 μm, D99 average particle size: 0.07 μm)

### <Binder Resin (E)>

Acrylic binder resin A: WEM-031U (manufactured by Taisei Fine Chemical Co., Ltd., non-volatile fraction: 39%)

Acrylic binder resin B: SUPERCHLON (a registered trademark) E-480T (manufactured by Nippon Paper Chemicals Co., Ltd., non-volatile fraction: 30%)

Acrylic binder resin C: AUROREN (a registered trademark) AE-301 (manufactured by Nippon Paper Chemicals Co., Ltd., non-volatile fraction: 30%)

Acrylic binder resin D: SB-1230N (manufactured by Unitika Ltd., non-volatile fraction: 20%)

Acrylic binder resin E: PDX-7158 (manufactured by BASF Corporation, non-volatile fraction: 41%)

Acrylic binder resin F: JONCRYL (a registered trademark) 690 (manufactured by BASF Corporation, non-volatile fraction: 98%)

Epoxy-based (water-based polyester) binder resin G: Newtrac (a registered trademark) 2010 (manufactured by Kao Corporation, non-volatile fraction: 20%)

Urethane-based binder resin H: CORONATE (a registered trademark) L-45E (manufactured by Nippon Polyurethane Industry Co., Ltd., non-volatile fraction: 45%)

### <Dispersant (D)>

Dispersant C: EMULGEN (a registered trademark) A60 (a polyoxyethylene distyrenated phenyl ether, manufactured by Kao Corporation, non-volatile fraction: 100%).
Dispersant D: KAOCER (a registered trademark) 2100 (manufactured by Kao Corporation, non-volatile fraction: 20%)

### <Dispersion Medium (C)>

Ion-exchanged water

### <Antifoaming Agents>

Antifoaming agent A: SN Defoamer 777 (manufactured by San Nopco Ltd.)

Antifoaming agent B: Surfynol (a registered trademark) 104E (acetylene glycol, manufactured by Nissin Chemical Co., Ltd.)

### <Rheology Control Agents>

Rheology Control Agent A: BYK425 (manufactured by BYK Chemie GmbH, non-volatile fraction: 50%)

Rheology Control Agent B: BYK428 (manufactured by BYK Chemie GmbH, non-volatile fraction: 25%)

### <Other>

Preservative: Levanax BX-50 (manufactured by Shoei Chemical Co., Ltd.) Thickener: AG gum (manufactured by Dai-Ichi Kogyo Seiyaku Co., Ltd.)

### <Substrates>

### [Substrate A (Substrate Production Example 1)]

Two parts by weight of titanium dioxide (JR-1000, manufactured by Tayca Corporation) and 98 parts by weight of a thermoplastic polypropylene resin (Lupilon S3000, manufactured by Mitsubishi Engineering-Plastics Corporation) were premixed, and were then placed in a biaxial extruder. Subsequently, the mixture was subjected to melt-kneading at 230° C., and then extruded to obtain a preliminary dispersion. This preliminary dispersion was placed in a mold, heated and melted at 230 to 250° C. using a hot press apparatus, and then allowed to cool, yielding a white substrate A capable of reflecting infrared radiation and having dimensions of width 100 mm, length 100 mm and thickness 2 mm.

### [Substrate B]

A copper sheet having dimensions of width 100 mm, length 100 mm and thickness 1 mm was used as a substrate B.

### [Substrate C]

An aluminum sheet having dimensions of width 100 mm, length 100 mm and thickness 1 mm was used as a substrate C.

### Dispersed Composition Preparation-2

### Example 201

The components listed below were placed in a beads mill dispersion device (Dyno-Mill KDL, manufactured by Tajima Kagaku Kikai Co., Ltd.) and dispersed to produce a dispersed composition 201. The dispersion conditions included a temperature of 40° C., the use of Zirconia beads with a diameter of 1.25 mm (manufactured by Nikkato Co., Ltd.), a fill factor of 80%, a circumferential speed of 10 m/second, a discharge rate of 300 to 500 g/minute, and a residence time of 15 minutes.

| | |
|---|---|
| Ultramarine A | 32.0 parts |
| Black inorganic pigment A | 8.0 parts |
| Dispersant C | 5.8 parts |
| Dispersant D | 1.5 parts |
| Antifoaming agent A | 0.1 parts |
| Preservative | 0.5 parts |
| Ion-exchanged water | 52.0 parts |

(The above composition had a non-volatile fraction of 47%)

### (Examples 202 to 210, Comparative Examples 201 to 204

With the exception of altering the pigments as shown in Table 7, dispersed compositions 202 to 214 were obtained in the same manner as Example 201.

Each of the obtained dispersed compositions 201 to 210 exhibited no separation or precipitation when allowed to stand at 50° C. for one week.

TABLE 7

| | | | | | Pigment 2 | | | | | Dispersant D | | | | Dis- |
|---|---|---|---|---|---|---|---|---|---|---|---|---|---|---|
| | | | | | (black | | Pigment weight | | Dis- | | parts (of | | | persion |
| | | Dispersed | | | inorganic | | ratio | | persant | | non- | Antifoaming | Preser- | medium |
| | | com- | Pigment 1 | | pigment) | | Pigment | Pigment | C | | volatile | agent A | vative | (water) |
| | | position | type | parts | type | parts | 1 | 2 | parts | parts | fraction) | parts | parts | parts |
| Example | 201 | 201 | Ultramarine A | 32.0 | A | 8.0 | 80.0 | 20.0 | 5.8 | 1.5 | 0.3 | 0.1 | 0.5 | 52.0 |
| | 202 | 202 | Ultramarine A | 28.0 | A | 12.0 | 70.0 | 30.0 | 5.8 | 1.5 | 0.3 | 0.1 | 0.5 | 52.0 |
| | 203 | 203 | Ultramarine A | 24.0 | A | 16.0 | 60.0 | 40.0 | 5.8 | 1.5 | 0.3 | 0.1 | 0.5 | 52.0 |
| | 204 | 204 | Ultramarine A | 20.0 | A | 20.0 | 50.0 | 50.0 | 5.8 | 1.5 | 0.3 | 0.1 | 0.5 | 52.0 |
| | 205 | 205 | Ultramarine A | 16.0 | A | 24.0 | 40.0 | 60.0 | 5.8 | 1.5 | 0.3 | 0.1 | 0.5 | 52.0 |
| | 206 | 206 | Ultramarine A | 12.0 | A | 28.0 | 30.0 | 70.0 | 5.8 | 1.5 | 0.3 | 0.1 | 0.5 | 52.0 |
| | 207 | 207 | Ultramarine A | 4.0 | A | 36.0 | 10.0 | 90.0 | 5.8 | 1.5 | 0.3 | 0.1 | 0.5 | 52.0 |
| | 208 | 208 | Ultramarine B | 20.0 | A | 20.0 | 50.0 | 50.0 | 5.8 | 1.5 | 0.3 | 0.1 | 0.5 | 52.0 |
| | 209 | 209 | Ultramarine C | 20.0 | A | 20.0 | 50.0 | 50.0 | 5.8 | 1.5 | 0.3 | 0.1 | 0.5 | 52.0 |
| | 210 | 210 | Ultramarine A | 20.0 | B | 20.0 | 50.0 | 50.0 | 5.8 | 1.5 | 0.3 | 0.1 | 0.5 | 52.0 |
| Com- | 201 | 211 | Ultramarine A | 40.0 | — | — | 100 | 0 | 5.8 | 1.5 | 0.3 | 0.1 | 0.5 | 52.0 |
| parative | 202 | 212 | — | — | A | 40.0 | 0 | 100 | 5.8 | 1.5 | 0.3 | 0.1 | 0.5 | 52.0 |
| Example | 203 | 213 | Carbon black B | 40.0 | — | — | 100 | 0 | 5.8 | 1.5 | 0.3 | 0.1 | 0.5 | 52.0 |
| | 204 | 214 | Perylene | 40.0 | — | — | 100 | 0 | 5.8 | 1.5 | 0.3 | 0.1 | 0.5 | 52.0 |
| | | | black A | | | | | | | | | | | |

### Coating Composition Preparation-2

### Example 301

Subsequently, using the obtained dispersed composition 201, the components listed below were mixed together and stirred for 30 minutes using a shaker to produce a coating composition 301.

| | |
|---|---|
| Dispersed composition 201 (non-volatile fraction) | 10.0 parts |
| Binder resin A (non-volatile fraction) | 20.0 parts |
| Rheology Control agent A | 1.5 parts |
| Rheology Control agent B | 1.0 parts |
| Preservative | 0.1 parts |
| Antifoaming agent B | 0.5 parts |
| Ethanol | 6.7 parts |
| Ion-exchanged water | 60.2 parts |

(The above composition had a non-volatile fraction of 32%)

### Examples 302 to 322, Comparative Examples 301 to 304

With the exception of altering the dispersed composition and the binder resin as shown in Table 8, coating compositions 302 to 326 were obtained in the same manner as Example 301. Each of the obtained coating compositions 301 to 322 exhibited no separation or precipitation when allowed to stand at 50° C. for one week.

TABLE 8

| | | | | | | | Binder resin | | |
|---|---|---|---|---|---|---|---|---|---|
| | | | Dispersed | | Pigment | | | | parts |
| | | Coating | composition | | weight ratio | | | | (of non-volatile |
| | | composition | type | parts | Pigment 1 | Pigment 2 | type | parts | fraction) |
| Example | 301 | 301 | 201 | 10 | 80.0 | 20.0 | Acrylic A | 20 | 7.8 |
| | 302 | 302 | 202 | 10 | 70.0 | 30.0 | | 20 | 7.8 |
| | 303 | 303 | 203 | 10 | 60.0 | 40.0 | | 20 | 7.8 |
| | 304 | 304 | 204 | 10 | 50.0 | 50.0 | | 20 | 7.8 |
| | 305 | 305 | 205 | 10 | 40.0 | 60.0 | | 20 | 7.8 |
| | 306 | 306 | 206 | 10 | 30.0 | 70.0 | | 20 | 7.8 |
| | 307 | 307 | 207 | 10 | 10.0 | 90.0 | | 20 | 7.8 |
| | 308 | 308 | 208 | 10 | 50.0 | 50.0 | | 20 | 7.8 |
| | 309 | 309 | 209 | 10 | 50.0 | 50.0 | | 20 | 7.8 |
| | 310 | 310 | 210 | 10 | 50.0 | 50.0 | | 20 | 7.8 |
| | 311 | 311 | 204 | 10 | 50.0 | 50.0 | Acrylic B | 20 | 6.0 |
| | 312 | 312 | 204 | 10 | 50.0 | 50.0 | Acrylic C | 20 | 6.0 |
| | 313 | 313 | 204 | 10 | 50.0 | 50.0 | Acrylic D | 20 | 4.0 |
| | 314 | 314 | 204 | 10 | 50.0 | 50.0 | Acrylic E | 20 | 8.2 |
| | 315 | 315 | 204 | 10 | 50.0 | 50.0 | Acrylic F | 20 | 19.6 |
| | 316 | 316 | 204 | 10 | 50.0 | 50.0 | Epoxy G | 20 | 4.0 |
| | 317 | 317 | 204 | 10 | 50.0 | 50.0 | Urethane H | 20 | 9.0 |
| | 318 | 318 | 204 | 10 | 50.0 | 50.0 | Acrylic A | 5 | 2.0 |
| | 319 | 319 | 204 | 10 | 50.0 | 50.0 | | 10 | 3.9 |
| | 320 | 320 | 204 | 10 | 50.0 | 50.0 | | 30 | 11.7 |
| | 321 | 321 | 204 | 10 | 50.0 | 50.0 | | 40 | 15.6 |
| | 322 | 322 | 204 | 10 | 50.0 | 50.0 | | 50 | 50.0 |
| Comparative | 301 | 323 | 211 | 10 | 100 | 0 | | 20 | 7.8 |
| Example | 302 | 324 | 212 | 10 | 0 | 100 | | 20 | 7.8 |
| | 303 | 325 | 213 | 10 | 100 | 0 | | 20 | 7.8 |
| | 304 | 326 | 214 | 10 | 100 | 0 | | 20 | 7.8 |

### Coating Film Preparation-2

### Example 401

The coating composition 301 was sprayed onto the substrate A using a spray gun (W-100, manufactured by Anest Iwata Corporation), and following natural drying for 30 minutes at room temperature with the substrate held in a horizontal position, the substrate was baked for 30 minutes in an oven at 80° C. to prepare a laminate (evaluation sample) having a coating film (also called the colored layer) with a thickness of 15 μm. The thus prepared laminate was measured for lightness, weather resistance and sunlight reflectivity using the methods described below.

### Examples 402 to 424, Comparative Examples 401 to 404

With the exception of altering the coating composition and the substrate as shown in Table 10, evaluation samples of Examples 402 to 424 and Comparative Examples 401 to 404 were obtained in the same manner as Example 401. Each of these evaluation samples was also measured for lightness, weather resistance and sunlight reflectivity.

The methods used for evaluating the lightness, the weather resistance and the sunlight reflectivity of the colored layer are described below, and the evaluation results are shown in Table 10.

### <Method of Measuring and Evaluating Lightness>

The lightness (L value) of the colored layer of each evaluation sample was measured using a color measurement apparatus (X-Rite 536, manufactured by S.D.G K.K.). A D50 light source was used as the measurement light source.

The lightness was evaluated against the 4-grade scale listed below.

A: less than 15.0 (extremely superior blackness)

B: at least 15.0, but less than 20.0 (superior blackness)

C: at least 20.0, but less than 25.0 (no problem from a practical perspective)

D: 25.0 or greater (poor)

### <Method of Measuring and Evaluating Weather Resistance>

The colored layer side of each evaluation sample was irradiated for 600 hours using a Super Xenon Weather Meter (SX-75, manufactured by Suga Test Instruments Co., Ltd.). The hue of the surface including the colored layer was measured using a color measurement apparatus (X-Rite 536, manufactured by S.D.G K.K.) before the irradiation and then after irradiation for 600 hours, and the hue difference was calculated using the same formula 2 as that used in Example 85. A D50 light source was used as the measurement light source.

The weather resistance was evaluated on the basis of the hue difference using the 3-grade scale listed below.

B: less than 5.0 (superior)

C: at least 5.0, but less than 8.0 (no problem from a practical perspective)

D: 8.0 or greater (poor)

### <Method of Measuring and Evaluating Sunlight Reflectivity>

The spectral reflectivity ρ(λ) of the colored layer side of each evaluation sample was measured at 300 to 2,500 nm by the diffuse reflectance method using a spectrophotometer UV-3600 (manufactured by Shimadzu Corporation) and an integrating sphere attachment ISR-240A (manufactured by Shimadzu Corporation). Based on the obtained spectral reflectivity data, and using the weighting coefficients illustrated in Table 9 for the region from 300 to 2,500 nm prescribed in JIS (Japan Industrial Standard) R3106, the sunlight reflectivity (ρe) was calculated using a formula 3. A high sunlight reflectivity indicates favorable infrared permeability for the colored layer, meaning the sample is resistant to overheating.

$${ρ}_{e} = \frac{{\sum }_{200}^{2500} ρ ( λ ) {E}_{λ} Δ λ}{{\sum }_{200}^{2500} {E}_{λ} Δλ} \qquad [ Formula 3 ]$$

ρe: sunlight reflectivity (%)

ρ(λ): spectral reflectivity

Eλ: relative spectral distribution of sunlight

Δλ: wavelength interval

TABLE 9

| Wavelength | Weighting coefficient |
|---|---|
| nm | E_{λ}Δλ |
| 300 | 0.000 000 |
| 305 | 0.000 057 |
| 310 | 0.000 236 |
| 315 | 0.000 554 |
| 320 | 0.000 916 |
| 325 | 0.001 309 |
| 330 | 0.001 914 |
| 335 | 0.002 018 |
| 340 | 0.002 189 |
| 345 | 0.002 260 |
| 350 | 0.002 445 |
| 355 | 0.002 555 |
| 360 | 0.002 683 |
| 365 | 0.003 020 |
| 370 | 0.003 359 |
| 375 | 0.003 509 |
| 380 | 0.003 600 |
| 385 | 0.003 529 |
| 390 | 0.003 551 |
| 395 | 0.004 294 |
| 400 | 0.007 812 |
| 410 | 0.011 638 |
| 420 | 0.011 877 |
| 430 | 0.011 347 |
| 440 | 0.013 246 |
| 450 | 0.015 343 |
| 460 | 0.016 166 |
| 470 | 0.016 178 |
| 480 | 0.016 402 |
| 490 | 0.015 794 |
| 500 | 0.015 801 |
| 510 | 0.015 973 |
| 520 | 0.015 357 |
| 530 | 0.015 867 |
| 540 | 0.015 827 |
| 550 | 0.015 844 |
| 560 | 0.015 590 |
| 570 | 0.015 256 |
| 580 | 0.014 745 |
| 590 | 0.014 330 |
| 600 | 0.014 663 |
| 610 | 0.015 030 |
| 620 | 0.014 859 |
| 630 | 0.014 622 |
| 640 | 0.014 526 |
| 650 | 0.014 445 |
| 660 | 0.014 313 |
| 670 | 0.014 023 |
| 680 | 0.012 838 |
| 690 | 0.011 788 |
| 700 | 0.012 453 |
| 710 | 0.012 798 |
| 720 | 0.010 589 |
| 730 | 0.011 233 |
| 740 | 0.012 175 |
| 750 | 0.012 181 |
| 760 | 0.009 515 |
| 770 | 0.010 479 |
| 780 | 0.011 381 |
| 790 | 0.011 262 |
| 800 | 0.028 718 |
| 850 | 0.048 240 |
| 900 | 0.040 297 |
| 950 | 0.021 384 |
| 1000 | 0.036 097 |
| 1050 | 0.034 110 |
| 1100 | 0.018 861 |
| 1150 | 0.013 228 |
| 1200 | 0.022 551 |
| 1250 | 0.023 376 |
| 1300 | 0.017 756 |
| 1350 | 0.003 743 |
| 1400 | 0.000 741 |
| 1450 | 0.003 792 |
| 1500 | 0.009 693 |
| 1550 | 0.013 693 |
| 1600 | 0.012 203 |
| 1650 | 0.010 615 |
| 1700 | 0.007 256 |
| 1750 | 0.007 183 |
| 1800 | 0.002 157 |
| 1850 | 0.000 398 |
| 1900 | 0.000 082 |
| 1950 | 0.001 087 |
| 2000 | 0.003 204 |
| 2050 | 0.003 988 |
| 2100 | 0.004 229 |
| 2150 | 0.004 142 |
| 2200 | 0.003 690 |
| 2250 | 0.003 592 |
| 2300 | 0.003 436 |
| 2350 | 0.003 163 |
| 2400 | 0.002 233 |
| 2450 | 0.001 202 |
| 2500 | 0.000 475 |
| Total | 0.999 999 |

The sunlight reflectivity (ρe) was evaluated against the 4-grade scale listed below.

A: 20% or greater (extremely superior)

B: at least 15%, but less than 20% (superior)

C: at least 10%, but less than 15% (no problem form a practical perspective)

D: less than 10% (poor)

TABLE 10

| | | | Coating | | Pigment weight ratio | | | Visual | Sunlight |
|---|---|---|---|---|---|---|---|---|---|
| | | Laminate | composition | Substrate | Pigment 1 | Pigment 2 | Lightness | evluation | reflectivity |
| Example | 401 | 1 | 301 | Substrate A | 80.0 | 20.0 | B | B | A |
| | 402 | 2 | 302 | | 70.0 | 30.0 | A | B | A |
| | 403 | 3 | 303 | | 60.0 | 40.0 | A | B | A |
| | 404 | 4 | 304 | | 50.0 | 50.0 | A | B | A |
| | 405 | 5 | 305 | | 40.0 | 60.0 | A | B | A |
| | 406 | 6 | 306 | | 30.0 | 70.0 | A | B | A |
| | 407 | 7 | 307 | | 10.0 | 90.0 | B | B | B |
| | 408 | 8 | 308 | | 50.0 | 50.0 | A | B | A |
| | 409 | 9 | 309 | | 50.0 | 50.0 | A | B | A |
| | 410 | 10 | 310 | | 50.0 | 50.0 | A | B | A |
| | 411 | 11 | 311 | | 50.0 | 50.0 | A | B | A |
| | 412 | 12 | 312 | | 50.0 | 50.0 | A | B | A |
| | 413 | 13 | 313 | | 50.0 | 50.0 | A | B | A |
| | 414 | 14 | 314 | | 50.0 | 50.0 | A | B | A |
| | 415 | 15 | 315 | | 50.0 | 50.0 | A | B | A |
| | 416 | 16 | 316 | | 50.0 | 50.0 | A | B | A |
| | 417 | 17 | 317 | | 50.0 | 50.0 | A | B | A |
| | 418 | 18 | 318 | | 50.0 | 50.0 | A | B | A |
| | 419 | 19 | 319 | | 50.0 | 50.0 | A | B | A |
| | 420 | 20 | 320 | | 50.0 | 50.0 | A | B | A |
| | 421 | 21 | 321 | | 50.0 | 50.0 | A | B | A |
| | 422 | 22 | 322 | | 50.0 | 50.0 | A | B | A |
| | 423 | 23 | 304 | Substrate B | 50.0 | 50.0 | A | B | A |
| | 424 | 24 | 304 | Substrate C | 50.0 | 50.0 | A | B | A |
| Comparative | 401 | 25 | 323 | Substrate A | 100 | 0 | D | B | A |
| Example | 402 | 26 | 324 | Substrate A | 0 | 100 | C | B | D |
| | 403 | 27 | 325 | Substrate A | 100 | 0 | A | B | D |
| | 404 | 28 | 326 | Substrate A | 100 | 0 | B | D | A |

As is evident from Examples 201 to 424 and Comparative Examples 201 to 404, the laminates of the present invention (Examples 401 to 424) exhibited evaluation results which presented no problems at a practical level for the lightness L, the weather resistance, and the sunlight reflectivity. Among the various laminates, when the pigment ratio between the ultramarine and the black inorganic pigment was within a range from 70/30 to 30/70 (Examples 402 to 406), the lightness L, the weather resistance and the sunlight reflectivity were all superior, and when the pigment ratio was from 60/40 to 40/60 (Examples 403 to 405), the lightness L and the sunlight reflectivity were extremely superior.

In contrast, when only ultramarine was used as the pigment (Comparative Example 401), although the weather resistance and the sunlight reflectivity were excellent, the lightness was inferior, and when only a black inorganic pigment was used as the pigment (Comparative Example 402), it was clear that the sunlight reflectivity was poor. Further, when the carbon black B was used as a pigment (Comparative Example 403), although the lightness was favorable, the sunlight reflectivity was poor, and when the perylene black A was used as a pigment (Comparative Example 404), it was clear that the weather resistance was inferior.

### Example Group B

Next is a description of Example Group B, in which an organic solvent was used as the dispersion medium. The materials and the like used in the examples and comparative examples in Example Group B are listed below.

### <Pigments>

Ultramarine A: Gunjo 8600P (as described above, C.I. Pigment Blue 29, manufactured by Daiichi Kasei Kogyo Co., Ltd., D50 average particle size: 0.6 μm, D99 average particle size: 1.6 μm, composition: 62% as Na₆(Al₆Si₆O₂₄).2NaS₃)
Ultramarine B: Nubix G58 (as described above, C.I. Pigment Blue 29, manufactured by Nubiola, D50 average particle size: 0.7 μm, D99 average particle size: 1.8 μm, composition: >99% as Na₆(Al₆Si₆O₂₄).2NaS₃)
Ultramarine C: Nubix EP62 (as described above, C.I. Pigment Blue 29, manufactured by Nubiola, D50 average particle size: 0.5 μm, D99 average particle size: 1.6 μm, composition: >99% as Na₆(Al₆Si₆O₂₄).2NaS₃)
Black inorganic pigment A: BAYFERROX 303T (as described above, C.I. Pigment Black 33, manufactured by LANXESS AG, D50 average particle size: 0.6 μm, D99 average particle size: 1.6 μm, composition: 77.2% as Fe₃O₄, 22% as MnO)
Black inorganic pigment B: BAYFERROX 360 (as described above, C.I. Pigment Black 11, manufactured by LANXESS AG, D50 average particle size: 0.7 μm, D99 average particle size: 1.7 μm, composition: >99% as Fe₃O₄)
Black inorganic pigment C: TAROX BL-100 (C.I. Pigment Black 11, manufactured by Titan Kogyo, Ltd., D50 average particle size: 0.7 μm, D99 average particle size: 1.8 μm, composition: >99% as Fe₃O₄)
Phthalocyanine blue A: LIONOL BLUE NCB Toner (as described above, C.I. Pigment Blue 15:3, manufactured by Toyochem Co., Ltd.)
Carbon black A: Raven 420 (as described above, C.I. Pigment Black 7, manufactured by Columbian Carbon Company)
Perylene black A: PALIOGEN BLACK 50084 (as described above, C.I. Pigment Black 31, manufactured by BASF Japan Ltd.)

### <Dispersants>

Dispersant E: BYK110 (a resin-type dispersant, manufactured by BYK Chemie GmbH)
Dispersant F: BYK180 (a resin-type dispersant, manufactured by BYK Chemie GmbH)
Dispersant G: SOLSPERSE 20000 (a resin-type dispersant, manufactured by The Lubrizol Corporation)

### <Binder Resins>

DIANAL HR-619 (an acrylic resin, Mitsubishi Rayon Co., Ltd., hereafter sometimes abbreviated as “HR” or “resin HR”)
DIANAL AR-2912 (an acrylic resin, Mitsubishi Rayon Co., Ltd., hereafter sometimes abbreviated as “AR” or “resin AR”)
CAB-551-0.2 (a cellulose acetate butyrate resin 30% in a mixed solution of butyl acetate/methyl isobutyl ketone=1/1, manufactured by Eastman Chemical Company, hereafter sometimes abbreviated as “CAB” or “resin CAB”)

### <Dispersion Medium>

Butyl acetate (hereafter sometimes abbreviated as “BA”)
Methyl isobutyl ketone (hereafter sometimes abbreviated as “MIBK”)
Xylene
Butanol (hereafter sometimes abbreviated as “BuOH”)
Butyl cellosolve (hereafter sometimes abbreviated as “BC”)
Methoxybutyl acetate (hereafter sometimes abbreviated as “MBA”)
Diethylene glycol monoethyl ether (hereafter sometimes abbreviated as “DEGMEE”)
Propylene glycol monoethyl ether (hereafter sometimes abbreviated as “PEGMEE”)

### <Curing Agents>

R-255 (polyisocyanate-based, manufactured by Nippon Bee Chemical Co., Ltd.)
R-271 (polyisocyanate-based, manufactured by Nippon Bee Chemical Co., Ltd.)
U-VAN (a registered trademark for an amino resin manufactured by Mitsui Toatsu Chemicals, Inc.) 20SE-60 (hereafter sometimes abbreviated as “SE”)

### <Substrates>

### [Substrate A (Substrate Production Example 1)]

Two parts of titanium dioxide (JR-1000, manufactured by Tayca Corporation) and 98 parts of a thermoplastic polypropylene resin (Lupilon 53000, manufactured by Mitsubishi Engineering-Plastics Corporation) were premixed, and were then placed in a biaxial extruder. Subsequently, the mixture was subjected to melt-kneading at 230° C., and then extruded to obtain a preliminary dispersion. This preliminary dispersion was placed in a mold, heated and melted at 230 to 250° C. using a hot press apparatus, and then allowed to cool, yielding a white substrate A capable of reflecting infrared radiation and having dimensions of width 100 mm, length 100 mm and thickness 2 mm.

### [Substrate B]

A copper sheet having dimensions of width 100 mm, length 100 mm and thickness 1 mm was used as a substrate B.

### [Substrate C]

An aluminum sheet having dimensions of width 100 mm, length 100 mm and thickness 1 mm was used as a substrate C.

### Dispersed Composition Preparation-3

### Example 501

| | |
|---|---|
| Ultramarine B | 1.72 parts |
| Black inorganic pigment A | 38.28 parts |
| Dispersant E | 3.85 parts |
| Resin AR | 14.29 parts |
| Butyl acetate | 20.93 parts |
| MIBK | 20.93 parts |

The above components were placed in a beads mill dispersion device (Dyno-Mill KDL) together with Unibeads UB2022S, and dispersion was performed under conditions including a fill factor of 80%, a circumferential speed of 10 m/second, a discharge rate of 300 to 500 g/minute, and a residence time of 15 minutes, thus obtaining a dispersed composition 501.

### Examples 502 to 522, 601 to 615, Comparative Examples 501 to 505

With the exception of replacing the components used in Example 501 with the components and blend ratios shown in Table 11 and Table 12, dispersed compositions 502 to 527 and 601 to 615 were obtained in the same manner as Example 501. The materials and pigment ratios (weight ratios) used in the dispersed compositions are shown in Tables 11 and 12.

TABLE 11

| | | | | | Pigment 2 | | | |
|---|---|---|---|---|---|---|---|---|
| | | | | | (black | | | |
| | | | | | inorganic | | | |
| | | Dispersed | Pigment 1 | | pigment) | | Pigment weight ratio | |
| | | composition | type | parts | type | parts | Pigment 1 | Pigment 2 |
| Example | 501 | 501 | Ultramarine B | 1.72 | A | 38.28 | 4.3 | 95.7 |
| | 502 | 502 | Ultramarine B | 10.32 | A | 29.68 | 25.8 | 74.2 |
| | 503 | 503 | Ultramarine B | 14.15 | A | 25.85 | 35.4 | 64.6 |
| | 504 | 504 | Ultramarine B | 16.08 | A | 23.92 | 40.2 | 59.8 |
| | 505 | 505 | Ultramarine B | 17.96 | A | 22.04 | 44.9 | 55.1 |
| | 506 | 506 | Ultramarine B | 21.24 | A | 18.76 | 53.1 | 46.9 |
| | 507 | 507 | Ultramarine A | 14.15 | A | 25.85 | 35.4 | 64.6 |
| | 508 | 508 | Ultramarine A | 14.15 | B | 25.85 | 35.4 | 64.6 |
| | 509 | 509 | Ultramarine A | 14.15 | C | 25.85 | 35.4 | 64.6 |
| | 510 | 510 | Ultramarine B | 14.15 | B | 25.85 | 35.4 | 64.6 |
| | 511 | 511 | Ultramarine B | 14.15 | C | 25.85 | 35.4 | 64.6 |
| | 512 | 512 | Ultramarine C | 14.15 | A | 25.85 | 35.4 | 64.6 |
| | 513 | 513 | Ultramarine C | 14.15 | B | 25.85 | 35.4 | 64.6 |
| | 514 | 514 | Ultramarine C | 14.15 | C | 25.85 | 35.4 | 64.6 |
| | 515 | 515 | Ultramarine B | 14.15 | A | 25.85 | 35.4 | 64.6 |
| | 516 | 516 | Ultramarine B | 14.15 | A | 25.85 | 35.4 | 64.6 |
| | 517 | 517 | Ultramarine B | 14.15 | A | 25.85 | 35.4 | 64.6 |
| | 518 | 518 | Ultramarine B | 14.15 | A | 25.85 | 35.4 | 64.6 |
| | 519 | 519 | Ultramarine B | 14.15 | A | 25.85 | 35.4 | 64.6 |
| | 520 | 520 | Ultramarine B | 14.15 | A | 25.85 | 35.4 | 64.6 |
| | 521 | 521 | Ultramarine B | 14.15 | A | 25.85 | 35.4 | 64.6 |
| | 522 | 522 | Ultramarine B | 14.15 | A | 25.85 | 35.4 | 64.6 |
| Comparative | 501 | 523 | Ultramarine B | 40.00 | — | — | 100 | 0 |
| Example | 502 | 524 | — | — | A | 40.00 | 0 | 100 |
| | 503 | 525 | Phthalocyanine blue A | 20.60 | A | 19.40 | 51.5 | 48.5 |
| | 504 | 526 | Carbon black A | 40.00 | — | — | 100 | 0 |
| | 505 | 527 | Perylene black A | 40.00 | — | — | 100 | 0 |
| Example | 601 | 601 | Ultramarine A | 28.00 | A | 12.00 | 70.0 | 30.0 |
| | 602 | 602 | Ultramarine A | 28.00 | B | 12.00 | 70.0 | 30.0 |
| | 603 | 603 | Ultramarine A | 28.00 | C | 12.00 | 70.0 | 30.0 |
| | 604 | 604 | Ultramarine B | 28.00 | A | 12.00 | 70.0 | 30.0 |
| | 605 | 605 | Ultramarine B | 28.00 | B | 12.00 | 70.0 | 30.0 |
| | 606 | 606 | Ultramarine B | 28.00 | C | 12.00 | 70.0 | 30.0 |
| | 607 | 607 | Ultramarine C | 28.00 | A | 12.00 | 70.0 | 30.0 |
| | 608 | 608 | Ultramarine C | 28.00 | B | 12.00 | 70.0 | 30.0 |
| | 609 | 609 | Ultramarine C | 28.00 | C | 12.00 | 70.0 | 30.0 |
| | 610 | 610 | Ultramarine B | 32.00 | A | 8.00 | 80.0 | 20.0 |
| | 611 | 611 | Ultramarine B | 14.15 | A | 25.85 | 35.4 | 64.6 |
| | 612 | 612 | Ultramarine B | 14.15 | A | 25.85 | 35.4 | 64.6 |
| | 613 | 613 | Ultramarine B | 14.15 | A | 25.85 | 35.4 | 64.6 |
| | 614 | 614 | Ultramarine B | 14.15 | A | 25.85 | 35.4 | 64.6 |
| | 615 | 615 | Ultramarine B | 14.15 | A | 25.85 | 35.4 | 64.6 |

TABLE 12

| | | | | | Binder | | Dispersion | | Dispersion | |
|---|---|---|---|---|---|---|---|---|---|---|
| | | Dispersed | Dispersant | | resin | | medium 1 | | medium 2 | |
| | | composition | type | parts | type | parts | type | parts | type | parts |
| Example | 501 | 501 | E | 3.85 | AR | 14.29 | BA | 20.93 | MIBK | 20.93 |
| | 502 | 502 | E | 3.85 | AR | 14.29 | BA | 20.93 | MIBK | 20.93 |
| | 503 | 503 | E | 3.85 | AR | 14.29 | BA | 20.93 | MIBK | 20.93 |
| | 504 | 504 | E | 3.85 | AR | 14.29 | BA | 20.93 | MIBK | 20.93 |
| | 505 | 505 | E | 3.85 | AR | 14.29 | BA | 20.93 | MIBK | 20.93 |
| | 506 | 506 | E | 3.85 | AR | 14.29 | BA | 20.93 | MIBK | 20.93 |
| | 507 | 507 | E | 3.85 | AR | 14.29 | BA | 20.93 | MIBK | 20.93 |
| | 508 | 508 | E | 3.85 | AR | 14.29 | BA | 20.93 | MIBK | 20.93 |
| | 509 | 509 | E | 3.85 | AR | 14.29 | BA | 20.93 | MIBK | 20.93 |
| | 510 | 510 | E | 3.85 | AR | 14.29 | BA | 20.93 | MIBK | 20.93 |
| | 511 | 511 | E | 3.85 | AR | 14.29 | BA | 20.93 | MIBK | 20.93 |
| | 512 | 512 | E | 3.85 | AR | 14.29 | BA | 20.93 | MIBK | 20.93 |
| | 513 | 513 | E | 3.85 | AR | 14.29 | BA | 20.93 | MIBK | 20.93 |
| | 514 | 514 | E | 3.85 | AR | 14.29 | BA | 20.93 | MIBK | 20.93 |
| | 515 | 515 | E | 3.85 | HR | 18.82 | BA | 18.67 | MIBK | 18.67 |
| | 516 | 516 | E | 3.85 | CAB | 26.67 | BA | 14.74 | MIBK | 14.74 |
| | 517 | 517 | E | 3.85 | AR | 14.29 | BA | 41.86 | — | — |
| | 518 | 518 | E | 3.85 | AR | 14.29 | MIBK | 41.86 | — | — |
| | 519 | 519 | E | 3.85 | AR | 14.29 | xylene | 41.86 | — | — |
| | 520 | 520 | F | 2.00 | AR | 14.29 | BA | 21.86 | MIBK | 21.86 |
| | 521 | 521 | G | 2.00 | AR | 14.29 | BA | 21.86 | MIBK | 21.86 |
| | 522 | 522 | — | — | AR | 17.86 | BA | 21.07 | MIBK | 21.07 |
| Comparative | 501 | 523 | E | 3.85 | AR | 14.29 | BA | 20.93 | MIBK | 20.93 |
| Example | 502 | 524 | E | 3.85 | AR | 14.29 | BA | 20.93 | MIBK | 20.93 |
| | 503 | 525 | E | 3.85 | AR | 14.29 | BA | 20.93 | MIBK | 20.93 |
| | 504 | 526 | E | 3.85 | AR | 14.29 | BA | 20.93 | MIBK | 20.93 |
| | 505 | 527 | E | 3.85 | AR | 14.29 | BA | 20.93 | MIBK | 20.93 |
| Example | 601 | 601 | E | 3.85 | AR | 14.29 | BA | 20.93 | MIBK | 20.93 |
| | 602 | 602 | E | 3.85 | AR | 14.29 | BA | 20.93 | MIBK | 20.93 |
| | 603 | 603 | E | 3.85 | AR | 14.29 | BA | 20.93 | MIBK | 20.93 |
| | 604 | 604 | E | 3.85 | AR | 14.29 | BA | 20.93 | MIBK | 20.93 |
| | 605 | 605 | E | 3.85 | AR | 14.29 | BA | 20.93 | MIBK | 20.93 |
| | 606 | 606 | E | 3.85 | AR | 14.29 | BA | 20.93 | MIBK | 20.93 |
| | 607 | 607 | E | 3.85 | AR | 14.29 | BA | 20.93 | MIBK | 20.93 |
| | 608 | 608 | E | 3.85 | AR | 14.29 | BA | 20.93 | MIBK | 20.93 |
| | 609 | 609 | E | 3.85 | AR | 14.29 | BA | 20.93 | MIBK | 20.93 |
| | 610 | 610 | E | 3.85 | AR | 14.29 | BA | 20.93 | MIBK | 20.93 |
| | 611 | 611 | E | 3.85 | AR | 14.29 | BuOH | 41.86 | — | — |
| | 612 | 612 | E | 3.85 | AR | 14.29 | BC | 41.86 | — | — |
| | 613 | 613 | E | 3.85 | AR | 14.29 | MBA | 41.86 | — | — |
| | 614 | 614 | E | 3.85 | AR | 14.29 | DEGMEE | 41.86 | — | — |
| | 615 | 615 | E | 3.85 | AR | 14.29 | PEGMEE | 41.86 | — | — |

### Coating Composition Preparation-3

### Example 523

| | |
|---|---|
| Dispersed composition 501 | 10.00 parts |
| Resin AR | 19.64 parts |
| Curing agent AB | 4.00 parts |

The above components were blended together to obtain a coating composition 501.

### Examples 524 to 544, 616 to 630, Comparative Examples 506 to 510

With the exception of replacing the dispersed composition 501 with the various combinations shown in Table 13, coating compositions 502 to 527 and 601 to 615 were obtained in the same manner as Example 523.

The materials and blend ratios (weight ratios) used in the above coating compositions are shown in Table 13.

TABLE 13

| | | | | | | Ratio |
|---|---|---|---|---|---|---|
| | | Coating | Dispersed | | | (dispersed composition/binder |
| | | composition | composition | Binder resin | Curing agent | resin/curing agent) |
| Example | 523 | 501 | 501 | AR | R-271 | 10.0/19.64/4.0 |
| | 524 | 502 | 502 | AR | R-271 | 10.0/19.64/4.0 |
| | 525 | 503 | 503 | AR | R-271 | 10.0/19.64/4.0 |
| | 526 | 504 | 504 | AR | R-271 | 10.0/19.64/4.0 |
| | 527 | 505 | 505 | AR | R-271 | 10.0/19.64/4.0 |
| | 528 | 506 | 506 | AR | R-271 | 10.0/19.64/4.0 |
| | 529 | 507 | 507 | AR | R-271 | 10.0/19.64/4.0 |
| | 530 | 508 | 508 | AR | R-271 | 10.0/19.64/4.0 |
| | 531 | 509 | 509 | AR | R-271 | 10.0/19.64/4.0 |
| | 532 | 510 | 510 | AR | R-271 | 10.0/19.64/4.0 |
| | 533 | 511 | 511 | AR | R-271 | 10.0/19.64/4.0 |
| | 534 | 512 | 512 | AR | R-271 | 10.0/19.64/4.0 |
| | 535 | 513 | 513 | AR | R-271 | 10.0/19.64/4.0 |
| | 536 | 514 | 514 | AR | R-271 | 10.0/19.64/4.0 |
| | 537 | 515 | 515 | FIR | SE | 10.0/27.76/5.34 |
| | 538 | 516 | 516 | CAB | R-255 | 10.0/10.0/20.0 |
| | 539 | 517 | 517 | AR | R-271 | 10.0/19.64/4.0 |
| | 540 | 518 | 518 | AR | R-271 | 10.0/19.64/4.0 |
| | 541 | 519 | 519 | AR | R-271 | 10.0/19.64/4.0 |
| | 542 | 520 | 520 | AR | R-271 | 10.0/19.64/4.0 |
| | 543 | 521 | 521 | AR | R-271 | 10.0/19.64/4.0 |
| | 544 | 522 | 522 | AR | R-271 | 10.0/19.64/4.0 |
| Comparative | 506 | 523 | 523 | AR | R-271 | 10.0/19.64/4.0 |
| Example | 507 | 524 | 524 | AR | R-271 | 10.0/19.64/4.0 |
| | 508 | 525 | 525 | AR | R-271 | 10.0/19.64/4.0 |
| | 509 | 526 | 526 | AR | R-271 | 10.0/19.64/4.0 |
| | 510 | 527 | 527 | AR | R-271 | 10.0/19.64/4.0 |
| Example | 616 | 601 | 601 | AR | R-271 | 10,0/19.64/4.0 |
| | 617 | 602 | 602 | AR | R-271 | 10.0/19.64/4.0 |
| | 618 | 603 | 603 | AR | R-271 | 10.0/19.64/4.0 |
| | 619 | 604 | 604 | AR | R-271 | 10.0/19.64/4.0 |
| | 620 | 605 | 605 | AR | R-271 | 10.0/19.64/4.0 |
| | 621 | 606 | 606 | AR | R-271 | 10.0/19.64/4.0 |
| | 622 | 607 | 607 | AR | R-271 | 10.0/19.64/4.0 |
| | 623 | 608 | 608 | AR | R-271 | 10.0/19.64/4.0 |
| | 624 | 609 | 609 | AR | R-271 | 10.0/19.64/4.0 |
| | 625 | 610 | 610 | AR | R-271 | 10.0/19.64/4.0 |
| | 626 | 611 | 611 | AR | R-271 | 10.0/19.64/4.0 |
| | 627 | 612 | 612 | AR | R-271 | 10.0/19.64/4.0 |
| | 628 | 613 | 613 | AR | R-271 | 10.0/19.64/4.0 |
| | 629 | 614 | 614 | AR | R-271 | 10.0/19.64/4.0 |
| | 630 | 615 | 615 | AR | R-271 | 10.0/19.64/4.0 |

### <Storage Stability of Dispersed Compositions and Coating Compositions>

The storage stability of each dispersed composition and coating composition was evaluated by leaving the composition to stand for one week, either at 25° C. or 50° C., and then inspecting the composition visually and evaluating the storage stability against the 4-grade scale listed below.

A: no separation or precipitation is noticeable (extremely superior)

B: some slight separation and precipitation is observed, but stirring returns the composition to a uniform state (superior)

C: some separation and precipitation is observed (slightly poor)

D: considerable separation and precipitation is observed (extremely poor)

The results of evaluating the storage stability of the dispersed compositions and the coating compositions are shown below in Table 14.

TABLE 14

| | | | Storage | Storage | | | | Storage | Storage |
|---|---|---|---|---|---|---|---|---|---|
| | | Dispersed | stability | stability | | | Coating | stability | stability |
| | | composition | (25° C.) | (50° C.) | | | composition | (25° C.) | (50° C.) |
| Example | 501 | 501 | A | B | Example | 523 | 501 | A | A |
| | 502 | 502 | A | B | | 524 | 502 | A | A |
| | 503 | 503 | A | A | | 525 | 503 | A | A |
| | 504 | 504 | A | A | | 526 | 504 | A | A |
| | 505 | 505 | A | A | | 527 | 505 | A | A |
| | 506 | 506 | A | A | | 528 | 506 | A | A |
| | 507 | 507 | A | A | | 529 | 507 | A | A |
| | 508 | 508 | A | A | | 530 | 508 | A | A |
| | 509 | 509 | A | A | | 531 | 509 | A | A |
| | 510 | 510 | A | A | | 532 | 510 | A | A |
| | 511 | 511 | A | A | | 533 | 511 | A | A |
| | 512 | 512 | A | A | | 534 | 512 | A | A |
| | 513 | 513 | A | A | | 535 | 513 | A | A |
| | 514 | 514 | A | A | | 536 | 514 | A | A |
| | 515 | 515 | A | A | | 537 | 515 | A | A |
| | 516 | 516 | A | A | | 538 | 516 | A | A |
| | 517 | 517 | A | A | | 539 | 517 | A | A |
| | 518 | 518 | A | A | | 540 | 518 | A | A |
| | 519 | 519 | A | A | | 541 | 519 | A | A |
| | 520 | 520 | A | A | | 542 | 520 | A | A |
| | 521 | 521 | A | A | | 543 | 521 | A | A |
| | 522 | 522 | A | B | | 544 | 522 | A | A |
| Comparative | 501 | 523 | A | A | Comparative | 506 | 523 | A | A |
| Example | 502 | 524 | A | B | Example | 507 | 524 | A | B |
| | 503 | 525 | D | D | | 508 | 525 | D | D |
| | 504 | 526 | A | C | | 509 | 526 | A | C |
| | 505 | 527 | D | D | | 510 | 527 | D | D |
| Example | 601 | 601 | A | A | Example | 616 | 601 | A | A |
| | 602 | 602 | A | A | | 617 | 602 | A | A |
| | 603 | 603 | A | A | | 618 | 603 | A | A |
| | 604 | 604 | A | A | | 619 | 604 | A | A |
| | 605 | 605 | A | A | | 620 | 605 | A | A |
| | 606 | 606 | A | A | | 621 | 606 | A | A |
| | 607 | 607 | A | A | | 622 | 607 | A | A |
| | 608 | 608 | A | A | | 623 | 608 | A | A |
| | 609 | 609 | A | A | | 624 | 609 | A | A |
| | 610 | 610 | A | A | | 625 | 610 | A | A |
| | 611 | 611 | A | A | | 626 | 611 | A | A |
| | 612 | 612 | A | A | | 627 | 612 | A | A |
| | 613 | 613 | A | A | | 628 | 613 | A | A |
| | 614 | 614 | A | A | | 629 | 614 | A | A |
| | 615 | 615 | A | A | | 630 | 615 | A | A |

### Coating Film Preparation-3

### Example 545

The coating composition 501 obtained in Example 523 was applied to a polyethylene terephthalate (PET) film having a thickness of 100 μm using a 7 mil applicator (resulting in an applied film thickness of 180 to 200 μm), and the applied composition was then dried to obtain a coating film 501. The drying conditions involved drying at 25° C. for 10 minutes, and then at 105° C. for 30 minutes.

### Examples 546 to 566, 631 to 645, Comparative Examples 511 to 515

With the exception of using the coating compositions 502 to 527 instead of the coating composition 501, coating films 502 to 527 and 601 to 615 were obtained in the same manner as Example 545.

### Preparation of Colored Items

### Example 567

The coating composition 501 was sprayed onto the substrate A using a spray gun (W-100, manufactured by Anest Iwata Corporation), and following natural drying for 30 minutes at room temperature with the substrate held in a horizontal position, the substrate was baked for 30 minutes in an oven at 105° C., thus obtaining a colored item 501 having a thickness of 15 μm.

### Examples 568 to 588, 646 to 660

With the exception of using the coating compositions 502 to 522 instead of the coating composition 501, colored items 502 to 522 and 601 to 615 were obtained in the same manner as Example 567.

### Example 589

With the exception of using the substrate B instead of the substrate A, a colored item 523 was obtained in the same manner as Example 567.

### Example 590

With the exception of using the substrate C instead of the substrate A, a colored item 524 was obtained in the same manner as Example 567.

### Comparative Examples 516 to 520

With the exception of using the coating compositions 523 to 527 instead of the coating composition 501, colored items 525 to 529 were obtained in the same manner as Example 567.

The results of evaluating the surface resistivity, the weather resistance, the degree of blackness (lightness and a visual evaluation) and the sunlight reflectivity for each of the above coating films and colored items are shown in Table 15 and Table 16. The surface resistivity, the weather resistance, the lightness and the visual evaluation were evaluated using the same evaluation methods and evaluation criteria described for Example 85 in Example Group A, whereas the sunlight reflectivity was evaluated using the same evaluation method and evaluation criteria described for Example 401 in Example Group A.

TABLE 15

| | | | Surface | Weather | | Visual | Sunlight |
|---|---|---|---|---|---|---|---|
| | | Coating film | resistivity | resistance | Lightness | evaluation | reflectivity |
| Example | 545 | 501 | A | A | A | B | B |
| | 546 | 502 | A | A | A | A | A |
| | 547 | 503 | A | A | A | A | A |
| | 548 | 504 | A | A | A | A | A |
| | 549 | 505 | A | A | A | A | A |
| | 550 | 506 | A | A | A | A | A |
| | 551 | 507 | A | A | A | A | A |
| | 552 | 508 | A | A | A | A | A |
| | 553 | 509 | A | A | A | A | A |
| | 554 | 510 | A | A | A | A | A |
| | 555 | 511 | A | A | A | A | A |
| | 556 | 512 | A | A | A | A | A |
| | 557 | 513 | A | A | A | A | A |
| | 558 | 514 | A | A | A | A | A |
| | 559 | 515 | A | A | A | A | A |
| | 560 | 516 | A | A | A | A | A |
| | 561 | 517 | A | A | A | A | A |
| | 562 | 518 | A | A | A | A | A |
| | 563 | 519 | A | A | A | A | A |
| | 564 | 520 | A | A | A | A | A |
| | 565 | 521 | A | A | A | A | A |
| | 566 | 522 | A | A | A | B | B |
| Comparative | 511 | 523 | B | A | D | D | A |
| Example | 512 | 524 | B | C | B | C | D |
| | 513 | 525 | D | C | B | B | C |
| | 514 | 526 | D | B | A | B | D |
| | 515 | 527 | C | D | D | C | A |
| Example | 631 | 601 | A | A | A | A | A |
| | 632 | 602 | A | A | A | A | A |
| | 633 | 603 | A | A | A | A | A |
| | 634 | 604 | A | A | A | A | A |
| | 635 | 605 | A | A | A | A | A |
| | 636 | 606 | A | A | A | A | A |
| | 637 | 607 | A | A | A | A | A |
| | 638 | 608 | A | A | A | A | A |
| | 639 | 609 | A | A | A | A | A |
| | 640 | 610 | A | A | A | B | B |
| | 641 | 611 | A | A | A | A | A |
| | 642 | 612 | A | A | A | A | A |
| | 643 | 613 | A | A | A | A | A |
| | 644 | 614 | A | A | A | A | A |
| | 645 | 615 | A | A | A | A | A |

TABLE 16

| | | | Surface | Weather | | Visual | Sunlight |
|---|---|---|---|---|---|---|---|
| | | Colored item | resistivity | resistance | Lightness | evaluation | reflectivity |
| Example | 567 | 501 | A | A | A | B | B |
| | 568 | 502 | A | A | A | A | A |
| | 569 | 503 | A | A | A | A | A |
| | 570 | 504 | A | A | A | A | A |
| | 571 | 505 | A | A | A | A | A |
| | 572 | 506 | A | A | A | A | A |
| | 573 | 507 | A | A | A | A | A |
| | 574 | 508 | A | A | A | A | A |
| | 575 | 509 | A | A | A | A | A |
| | 576 | 510 | A | A | A | A | A |
| | 577 | 511 | A | A | A | A | A |
| | 578 | 512 | A | A | A | A | A |
| | 579 | 513 | A | A | A | A | A |
| | 580 | 514 | A | A | A | A | A |
| | 581 | 515 | A | A | A | A | A |
| | 582 | 516 | A | A | A | A | A |
| | 583 | 517 | A | A | A | A | A |
| | 584 | 518 | A | A | A | A | A |
| | 585 | 519 | A | A | A | A | A |
| | 586 | 520 | A | A | A | A | A |
| | 587 | 521 | A | A | A | A | A |
| | 588 | 522 | A | A | A | B | B |
| | 589 | 523 | A | A | A | B | B |
| | 590 | 524 | A | A | A | B | B |
| Comparative | 516 | 525 | B | A | D | D | A |
| Example | 517 | 526 | B | C | B | C | D |
| | 518 | 527 | D | C | B | B | C |
| | 519 | 528 | D | B | A | B | D |
| | 520 | 529 | C | D | D | C | A |
| Example | 646 | 601 | A | A | A | A | A |
| | 647 | 602 | A | A | A | A | A |
| | 648 | 603 | A | A | A | A | A |
| | 649 | 604 | A | A | A | A | A |
| | 650 | 605 | A | A | A | A | A |
| | 651 | 606 | A | A | A | A | A |
| | 652 | 607 | A | A | A | A | A |
| | 653 | 608 | A | A | A | A | A |
| | 654 | 609 | A | A | A | A | A |
| | 655 | 610 | A | A | A | B | B |
| | 656 | 611 | A | A | A | A | A |
| | 657 | 612 | A | A | A | A | A |
| | 658 | 613 | A | A | A | A | A |
| | 659 | 614 | A | A | A | A | A |
| | 660 | 615 | A | A | A | A | A |

As is evident from Examples 501 to 590, 601 to 660 and Comparative Examples 501 to 520, the coating films and colored items which used the dispersed compositions of the present invention exhibited superior results, with no problems of a practical level, in all the evaluation results for surface resistivity, weather resistance, degree of blackness (lightness and the visual evaluation) and sunlight reflectivity. In contrast, it was clear that when only ultramarine was used as the pigment (Comparative Examples 511 and 516), although the weather resistance and the sunlight reflectivity were excellent, the lightness and the visual evaluation were inferior, and when only a black inorganic pigment was used as the pigment (Comparative Examples 512 and 517), it was clear that the weather resistance, the visual evaluation and the sunlight reflectivity were poor. Further, when phthalocyanine blue was used instead of the ultramarine (Comparative Examples 513 and 518), it was clear that the surface resistivity, the weather resistance and the sunlight reflectivity were poor. When carbon black was used as the pigment (Comparative Examples 514 and 519), it was clear that the surface resistivity and the sunlight reflectivity were inferior. Moreover, when perylene black was used as the pigment (Comparative Examples 515 and 520)), it was clear that the surface resistivity, the weather resistance and the lightness were poor.

### INDUSTRIAL APPLICABILITY

The present invention is able to provide a dispersed composition and a black coating composition having excellent storage stability, blackness and weather resistance. Moreover, the present invention can also provide a black dispersed composition, a black coating composition and a coating film having a high surface resistivity (an antistatic effect). These compositions and coating films are useful in fields such as black matrices for color filters used in any of various displays, and interior and exterior automotive coating materials, which require a high degree of blackness and a high surface resistivity. Further, the present invention can also provide a black dispersed composition and a heat-shielding coating film that exhibit excellent infrared permeability, which are useful in fields such as shielding coating materials which require a high degree of blackness and superior infrared permeability.

1: A dispersed composition comprising an ultramarine (A), a black inorganic pigment (B) (excluding carbon black), and a dispersion medium (C), wherein a weight ratio of ultramarine (A)/black inorganic pigment (B) is from 80/20 to 4.3/95.7.

2: The dispersed composition according to claim 1, wherein the black inorganic pigment (B) is a black inorganic pigment composed of a metal oxide.

3: The dispersed composition according to claim 1, wherein the black inorganic pigment (B) is C.I. Pigment Black 11 or C.I. Pigment Black 33.

4: The dispersed composition according to claim 1, wherein a D50 average particle size of the ultramarine (A) is from 0.1 to 1 μm, and a D50 average particle size of the black inorganic pigment (B) is from 0.1 to 1 μm.

5: The dispersed composition according to claim 1, wherein a D99 average particle size of the ultramarine (A) is from 1 to 10 μm.

6: The dispersed composition according to claim 1, wherein a D99 average particle size of the black inorganic pigment (B) is from 1 to 10 μm.

7: The dispersed composition according to claim 1, further comprising a dispersant (D).

8: The dispersed composition according to claim 1, wherein the dispersion medium (C) comprises an organic solvent.

9: The dispersed composition according to claim 1, wherein the dispersion medium (C) comprises one or more organic solvents selected from the group consisting of ketones, esters, alcohols, ethers, and aromatic hydrocarbons.

10: The dispersed composition according to claim 1, wherein the dispersion medium (C) comprises water, and at least one solvent selected from the group consisting of water-soluble organic solvents.

11: The dispersed composition according to claim 7, wherein the dispersant (D) is at least one of a nonionic surfactant and an anionic surfactant.

12: The dispersed composition according to claim 7, wherein the dispersant (D) is a resin-type dispersant.

13: A coating composition comprising the dispersed composition according to claim 1, and at least one of a binder resin (E) and a curing agent (F).

14: A coating film formed from the coating composition according claim 13.

15: The coating film according to claim 14, wherein a surface resistivity of the coating film is 10¹⁰ Ω/square or greater.

16: The coating film according to claim 14, wherein a lightness (L value) of the coating film is 22.0 or less.

17: A colored item comprising a substrate and the coating film according to claim 14.
